(19) United States
(12) Patent Application Publication
(10) Pub. No.: US 2024/0072302 A1
(43) Pub. Date: Feb. 29, 2024

(54) PHOSPHORUS-NITROGEN FLUIDS AS PLASTICIZERS FOR SOLID ELECTROLYTE BATTERY

(71) Applicant: New Dominion Enterprises, Inc., Austin, TX (US)

(72) Inventor: Mason K. Harrup, Idaho Falls, ID (US)

(21) Appl. No.: 18/238,043

(22) Filed: Aug. 25, 2023

Related U.S. Application Data
(60) Provisional application No. 63/398,019, filed on Aug. 15, 2022.

(51) Int. Cl. H01M 10/0565; C07F 9/535; H01M 10/0525; H01M 10/0585; H01M 50/414; H01M 50/497

(52) U.S. Cl. CPC H01M 10/0565; C07F 9/5355; H01M 10/0525; H01M 10/0585; H01M 50/414; H01M 50/497; H01M 2300/0082

(57) ABSTRACT

A solid electrolyte, comprising a solid polymer, ceramic, and/or polymer/ceramic composite materials and a phosphorus-containing plasticizer selected from the group consisting of a phosphazene and a phosphoranimine, which lacks hydroxyl and unstable phosphorus-halogen bonds, is electrochemically stable at a voltage of at least 3.5 V (vs. Li/Li⁺), and has a flash point of at least 100° C., wherein the solid electrolyte has a lithium ion conductivity of at least 1×10⁻⁶ S/cm.

### CROSS REFERENCE TO RELATED APPLICATIONS

The present application claims benefit of priority under 35 U.S.C. § 119(e) from U.S. Provisional Patent Application No. 63/398,019, filed Aug. 15, 2022, the entirety of which is expressly incorporated herein by reference.

### FIELD OF THE INVENTION

The present invention relates to the field of solid electrolyte batteries, and in particular phosphorus-nitrogen compounds for use in the solid electrolytes.

### BACKGROUND OF THE INVENTION

Each reference or patent mentioned herein is expressly incorporated herein by reference in its entirety for all purposes.

Batteries with high activity metals, i.e., cell potentials above about 1.5 V, are subject to hydrolysis of aqueous electrolytes. Therefore, rechargeable high energy batteries typically employ non-aqueous electrolytes which lack free hydroxyl substituents. Other criteria for suitable electrolytes are solubility for a supporting salt which yields a charge carrier ion in sufficient concentration to permit high current density, while avoiding strongly bound complexes of the charge carrier ion with the solvent, and a sufficiently low viscosity to permit efficient charge carrier transport through the electrolyte. Further, the battery typically has a storage temperature range of 0° C. or below to 60° C. or above, and the electrolyte should be reasonably stable within that range. Finally, the electrolyte should be chemically inert with respect to the battery chemistry, with the exception of the formation of a stable solid electrolyte interphase (SEI) layer near the reactive surface of the electrode, which permits flow of the charge carrier ions between the bulk electrolyte solution and the electrode surfaces, while protecting the bulk electrolyte solution from large-scale decomposition by the electrochemical reactions that occur during cycling. The SEI should be dynamic, and reform as required under normal battery cycling conditions from the bulk electrolyte solution.

Lithium-ion batteries have been in widespread use for decades. These energy storage systems have been investigated for a wide variety of applications, from small single cell platforms, such as watches, phones and the like; to larger format platforms such as those applicable for transportation systems and potentially grid-scale energy storage. A considerable limitation of lithium-ion batteries containing lithium salts in organic solvents, such as ethylene carbonate and ethyl methyl carbonate, is the potential for the ignition of the flammable electrolyte solution under certain operating conditions. Also notable is the degradation of the solvent and the formation of the SEI under current draw that can raise the temperature and hence the internal pressure generated causing the battery cell to rupture. Multiple approaches to effect the replacement of organic solvents from battery electrolytes have been investigated over the past 20+ years. Some have limiting requirements that make them impractical for wide-scale adoption for common multi-cell applications, such as thermal requirements (molten salts) and complex engineering designs (flow batteries). There is a pressing need for a complete replacement of current organic electrolyte systems without these constraints. One area that has shown promise of fulfilling these stringent requirements is through the use of phosphorus-based inorganic compounds. The present invention leverages compounds of this nature to achieve the goal of eliminating all organic components from the electrolyte system for a wide variety of lithium ion-based energy storage platforms.

Most of the commercial electrolytes for lithium-ion batteries are LiPF₆ salt dissolved in a mixture of organic carbonate and/or ester solvents. These electrolyte blends are highly volatile and highly flammable, with typical flash points as low as 30° C. or less. This presents serious safety concerns especially when utilized in large format cells or when the cells come under undue stress or physical damage. One approach to improve the safety performance of the electrolyte is to use additives and co-solvents to reduce the flammability of the organic carbonate and ester electrolytes. A variety of additives and co-solvents have been proposed, including sulfones, ionic liquids, phosphates, phospholanes, phosphazenes (PZs), siloxanes, fluorinated carbonates, and fluorinated ethers and mixtures thereof. In addition to flammability suppression, additives have also been used to improve SEI formation, and to provide overcharge protection and thermal stability.

Electrolyte solutions used in lithium-ion batteries are known to be unstable at high temperatures and high voltages. Over time, the organic electrolyte solution turns into a tar-like material at even modest temperatures (as low as 55° C.). These electrolyte solutions may include carbonate-based solvents, such as dimethyl carbonate (DMC), ethylene carbonate (EC), ethylmethyl carbonate (EMC), etc. These carbonate-based solvents are also problematic due to their high volatility, flammability, and toxicity. Further complicating this issue is the fact that they readily decompose at even modestly elevated temperatures, such as low as 55° C.

Lithium metal anodes provide the highest capacity and the lowest potential of all anode materials. Therefore, it is not only used in commercial primary lithium metal batteries, but is also proposed as an anode material in rechargeable lithium batteries. In addition, they are being studied in more far-reaching cell designs, such as lithium/air and lithium/sulfur batteries, which are considered as super-high specific energy systems of tomorrow. High energy batteries are urgently demanded to meet a longer driving range in electric vehicles (electro-mobility). However, the rechargeable lithium metal anode suffers from poor rechargeability and very low safety. Due to their low potential, the electrolytes traditionally used are not thermodynamically stable against lithium. Their reductive decomposition and the parallel corrosion of the Li electrode leads to the formation of the solid electrolyte interphase (SEI). This passivating film is designed to slow down or in the ideal case even prevent electrolyte decomposition. However, in practical systems this degradation of the lithium and the conventional electrolyte occurs so rapidly, that the battery suffers early battery death as well as severe safety consequences. Exacerbating this negative safety consequence, heterogeneous lithium deposition and dissolution during charge and discharge of the lithium metal anode eventually leads to high surface area lithium, commonly called lithium dendrites, in organic solvent-based electrolytes. This may cause a loss of active material due to enhanced lithium corrosion at the high surface area Li, as well as due to the disconnection of dendrites from electronic contact. Most importantly, a short-circuit of the cell may happen when the dendrites grow across the electrolyte to the cathode. In any case, the continuous creation of new lithium surfaces by dendrite formation leads to continuous electrolyte decomposition during cycling.

Overpotentials are generated by kinetic hindrances in the system. In lithium plating and stripping processes, these may include the lithium-ion transport in the electrolyte and in the electrode/electrolyte interphase, and always the kinetic hindrance of the lithium-ion reduction and oxidation processes at the electrode itself, introducing additional charge transfer resistance.

To reduce the flammability of the electrolyte solution, organophosphorus compounds, such as phosphates and cyclic PZs, have been investigated as an additive or co-solvent to the electrolyte solution. Phosphoranimines (PAs) compounds, which include a phosphorus-nitrogen double bond, and additional substituents on the phosphorus and nitrogen, are known in the art as synthetic intermediates in the formation of polyphosphazene compounds or cyclic PZ compounds. PA compounds have been disclosed for use in electrolyte solutions in combination with an aprotic organic solvent.

US 20150340739, (Klaehn et al.), expressly incorporated herein by reference in its entirety, discloses an electrolyte solution comprising at least one PA compound and a metal salt. The at least one PA compound comprises a compound of the chemical structure X—N═P(R1,R2,R3), where X is an organosilyl group (e.g., trimethyl silyl), an alkyl group, or an aryl group (e.g., a tert-butyl group) and each of R1, R2, and R3 is independently selected from the group consisting of an alkyl group, an aryl group, an alkoxy group, or an aryloxy group, or a sulfur or nitrogen analogue thereof. The PA compound is an acyclic (e.g., linear) compound that includes a double bond between a phosphorus atom and a nitrogen atom of the PA compound. Three pendant groups are bonded to the phosphorus atom, and a pendant group is bonded to the nitrogen atom. The PA compound is a monomeric PZ compound. A cationic pendant group may also be used as at least one of R1, R2, and R3. The choice of functional group (X) bonded to the nitrogen atom may be more limited by synthetic chemistry techniques than is the choice of functional group bonded to the phosphorus atom. The pendant groups on each of the phosphorus atom and the nitrogen atom may be the same as, or different from, one another. The PA compound should not include a halogen directly bonded to the phosphorus for stability. However, a halogen may otherwise be a substituent. See also US 20160285125, 20170040638, 20210043969, U.S. Pat. No. 10,367,229; and 9,761,910.

See, U.S. Pat. Nos. 4,248,868; 4,613,676; 4,719,288; 4,722,877; 4,727,060; 4,772,433; 4,810,599; 4,828,945; 4,863,903; 4,931,591; 4,985,317; 5,041,346; 5,061,581; 5,110,694; 5,114,809; 5,153,080; 5,153,082; 5,176,969; 5,180,645; 5,188,783; 5,190,695; 5,337,184; 5,420,000; 5,426,005; 5,443,601; 5,474,860; 5,548,055; 5,567,783; 5,576,120; 5,591,545; 5,633,098; 5,660,948; 5,672,446; 5,672,465; 5,698,338; 5,700,298; 5,707,760; 5,725,968; 5,728,489; 5,731,104; 5,744,264; 5,753,388; 5,756,231; 5,780,182; 5,783,333; 5,786,110; 5,789,110; 5,824,434; 5,843,592; 5,851,504; 5,912,093; 5,962,169; 5,998,559; 6,007,947; 6,013,393; 6,015,638; 6,087,426; 6,096,453; 6,103,419; 6,103,426; 6,168,885; 6,207,326; 6,316,149; 6,379,842; 6,391,492; 6,395,423; 6,413,675; 6,413,676; 6,416,905; 6,444,370; 6,447,952; 6,472,104; 6,475,679; 6,475,680; 6,492,449; 6,599,664; 6,605,237; 6,645,675; 6,664,006; 6,699,623; 6,721,168; 6,759,164; 6,759,460; 6,797,019; 6,815,119; 6,828,065; 6,841,301; 6,893,774; 6,908,186; 6,955,867; 7,005,206; 7,008,564; 7,052,805; 7,060,744; 7,067,219; 7,077,516; 7,081,320; 7,084,290; 7,091,266; 7,094,501; 7,099,142; 7,118,694; 7,226,702; 7.229,719; 7,238,450; 7,247,740; 7,273,597; 7,285,362; 7,316,855; 7,378,193; 7,410,731; 7,429,433; 7,473,491; 7,494,745; 7,498,102; 7,524,439; 7,557,637; 7,560,595; 7,579,118; 7,582,380; 7,585,587; 7,585,994; 7,588,859; 7,598,002; 7,656,125; 7,678,505; 7,695,860; 7,695,862; 7,713,449; 7,718,321; 7,718,826; 7,759,418; 7,781,105; 7,811,707; 7,811,708; 7,820,328; 7,824,800; 7,828,728; 7,838,143; 7,851,090; 7,875,204; 7,875,393; 7,939,199; 7,939,206; 7,951,495; 7,976,983; 7,977,393; 7,989,109; 8,000,084; 8,003,241; 8,003,256; 8,012,615; 8,030,500; 8,034,491; 8,048,569; 8,062,796; 8,071,233; 8,076,031; 8,076,032; 8,084,998; 8,092,940; 8,119,038; 8,124,269; 8,133,614; 8,137,844; 8,153,307; 8,168,330; 8,168,831; 8,178,009; 8,187,749; 8,211,336; 8,221,915; 8,227,103; 8,236,449; 8,257,866; 8,257,870; 8,263,697; 8,268,197; 8,287,483; 8,301,322; 8,308,971; 8,309,240; 8,357,450; 8,367,755; 8,377,596; 8,384,058; 8,415,045; 8,420,266; 8,450,012; 8,455,141; 8,465,871; 8,470,472; 8,486,560; 8,486,565; 8,512,896; 8,512,899; 8,524,399; 8,556,996; 8,562,873; 8,574,773; 8,579,994; 8,592,081; 8,597,815; 8,597,827; 8,628,873; 8,652,688; 8,658,062; 8,669,114; 8,673,499; 8,679,670; 8,679,684; 8,686,074; 8,703,310; 8,703,344; 8,715,863; 8,728,170; 8,734,668; 8,734,674; 8,734,988; 8,741,486; 8,754,138; 8,765,295; 8,778,533; 8,785,022; 8,795,886; 8,795,903; 8,801,810; 8,802,285; 8,814,956; 8,815,432; 8,822,084; 8,822,088; 8,828,605; 8,841,035; 8,845,764; 8,846,249; 8,846,251; 8,846,922; 8,852,801; 8,852,813; 8,870,810; 8,871,385; 8,889,301; 8,900,754; 8,906,549; 8,922,959; 8,927,127; 8,945,774; 8,974,947; 8,986,881; 8,999,009; 9,012,093; 9,012,094; 9,077,037; 9,077,046; 9,093,716; 9,099,252; 9,099,756; 9,105,908; 9,105,942; 9,111,684; 9,112,212; 9,118,088; 9,123,973; 9,130,214; 9,130,245; 9,142,357; 9,147,906; 9,166,206; 9,166,222; 9,166,249; 9,172,076; 9,172,088; 9,172,094; 9,183,995; 9,184,467; 9,184,468; 9,190,616; 9,190,695; 9,190,698; 9,196,926; 9,203,084; 9,203,107; 9,203,113; 9,206,210; 9,207,513; 9,209,456; 9,214,659; 9,219,274; 9,227,850; 9,230,746; 9,231,243; 9,236,634; 9,236,635; 9,240,614; 9,246,150; 9,252,399; 9,257,720; 9,2637,31; 9,263,764; 9,273,399; 9,281,541; 9,281,543; 9,284,324; 9,287,560; 9,293,749; 9,293,787; 9,293,796; RE37,076; 20010004506; 20010004507; 20010012590; 20020014616; 20020031701; 20020039275; 20020048706; 20020055047; 20020076611; 20020085968; 20020090331; 20020090547; 20020094311; 20020098135; 20020100725; 20020102196; 20020110739; 20020122979; 20020127162; 20020127169; 20020127454; 20020128364; 20020136681; 20020136683; 20020150524; 20020155353; 20020159943; 20020160270; 20020182488; 20020185627; 20020193533; 20020197522; 20020197531; 20030003369; 20030059683; 20030068555; 20030091904; 20030108801; 20030113635; 20030125437; 20030129500; 20030148191; 20030170548; 20030175597; 20030175598; 20030190531; 20030198868; 20040009404; 20040013927; 20040039134; 20040053138; 20040085710; 20040126305; 20040126658; 20040126659; 20040139587; 20040142246; 20040146778; 20040146786; 20040151985; 20040157122; 20040158091; 20040170901; 20040189762; 20040189763; 20040191635; 20040192853; 20040220348; 20050008938; 20050042503; 20050085655; 20050095197; 20050095504; 20050106458; 20050106460; 20050123836; 20050136329; 20050153207; 20050158626; 20050164093; 20050175529; 20050175904; 20050181280; 20050214700; 20050215764; 20050221168; 20050228087; 20050249656; 20050249667; 20050255385; 20050260120; 20050272214; 20060032046; 20060034943; 20060035137; 20060046151; 20060073381; 20060121355; 20060147371; 20060147807; 20060154144; 20060154147; 20060166098; 20060172200; 20060180796; 20060194119; 20060204856; 20060210873; 20060210883; 20060217568; 20060269834; 20060281010; 20060281011; 20060292451; 20070020529; 20070026315; 20070027129; 20070029972; 20070037046; 20070037063; 20070040154; 20070043158; 20070048209; 20070048596; 20070048622; 20070048623; 20070054180; 20070077496; 20070092549; 20070117007; 20070141470; 20070149496; 20070166617; 20070172740; 20070180688; 20070182418; 20070183954; 20070207384; 20070212615; 20070216469; 20070243470; 20070298314; 20080008928; 20080008933; 20080020276; 20080020285; 20080044736; 20080051495; 20080063585; 20080063588; 20080075999; 20080089830; 20080096056; 20080099734; 20080107586; 20080118428; 20080118843; 20080119421; 20080138700; 20080152996; 20080153005; 20080160417; 20080164444; 20080171268; 20080176141; 20080193840; 20080193848; 20080213588; 20080213661; 20080224100; 20080233477; 20080241693; 20080241699; 20080254361; 20080261116; 20080269492; 20080311025; 20090004094; 20090005824; 20090011340; 20090017364; 20090023071; 20090027827; 20090029138; 20090029193; 20090035656; 20090075176; 20090081547; 20090081548; 20090104523; 20090123813; 20090130567; 20090136854; 20090155696; 20090155697; 20090169463; 20090181296; 20090186267; 20090191464; 20090208835; 20090246625; 20090246628; 20090253035; 20090253046; 20090256528; 20090259420; 20090269654; 20090269673; 20090280400; 20090291330; 20090297937; 20090305016; 20090311587; 20100009260; 20100015521; 20100018034; 20100047695; 20100062345; 20100068461; 20100068605; 20100075222; 20100075225; 20100078599; 20100086823; 20100090650; 20100119881; 20100119956; 20100124691; 20100125082; 20100125087; 20100136410; 20100143770; 20100159346; 20100164436; 20100167121; 20100173139; 20100178555; 20100183917; 20100190059; 20100200403; 20100209782; 20100216016; 20100216027; 20100224824; 20100233523; 20100240813; 20100255356; 20100279155; 20100285352; 20100285354; 20100285358; 20100285373; 20100297502; 20100299008; 20100304205; 20100304223; 20100310941; 20100323238; 20100330410; 20100330419; 20100330421; 20100330423; 20100330425; 20110014527; 20110020704; 20110020706; 20110024396; 20110027656; 20110033734; 20110033756; 20110039157; 20110049745; 20110052966; 20110059349; 20110067230; 20110070495; 20110070504; 20110077880; 20110081563; 20110081581; 20110086781; 20110097628; 20110097630; 20110098463; 20110104553; 20110104565; 20110111294; 20110111304; 20110117407; 20110117445; 20110117446; 20110123869; 20110136019; 20110143201; 20110143219; 20110159329; 20110159365; 20110159377; 20110159379; 20110171502; 20110177393; 20110181249; 20110183216; 20110189512; 20110189520; 20110189548; 20110189579; 20110195318; 20110200874; 20110206979; 20110206994; 20110207000; 20110229761; 20110236751; 20110236765; 20110250503; 20110256457; 20110264381; 20110274977; 20110287316; 20110287318; 20110293997; 20110301931; 20110305949; 20110305958; 20110319426; 20120003514; 20120003518; 20120007560; 20120015249; 20120021286; 20120028105; 20120034512; 20120045670; 20120052401; 20120058377; 20120060360; 20120064396; 20120070741; 20120077076; 20120077082; 20120082873; 20120082890; 20120082902; 20120082903; 20120088155; 20120088162; 20120094178; 20120100438; 20120105007; 20120107680; 20120107697; 20120107726; 20120115018; 20120121974; 20120121989; 20120121991; 20120129019; 20120129046; 20120133341; 20120135312; 20120141864; 20120141866; 20120141867; 20120141869; 20120141878; 20120141883; 20120141884; 20120148922; 20120155507; 20120164519; 20120164541; 20120169297; 20120171536; 20120171542; 20120175552; 20120177995; 20120183842; 20120183843; 20120183856; 20120183865; 20120183866; 20120188086; 20120189920; 20120202112; 20120208087; 20120218683; 20120219865; 20120225331; 20120225358; 20120225359; 20120231308; 20120231325; 20120231352; 20120244391; 20120244417; 20120251886; 20120251892; 20120273737; 20120276445; 20120288750; 20120288751; 20120288769; 20120289887; 20120293916; 20120295155; 20120295165; 20120301789; 20120301797; 20120308894; 20120315535; 20120315549; 20120321959; 20120328942; 20120328952; 20130004839; 20130004862; 20130011728; 20130011736; 20130017443; 20130017453; 20130022863; 20130022880; 20130026409; 20130040203; 20130043843; 20130048923; 20130052528; 20130052542; 20130055559; 20130059172; 20130065122; 20130065130; 20130069601; 20130069658; 20130069661; 20130071733; 20130071739; 20130071762; 20130072154; 20130078525; 20130084495; 20130084496; 20130084501; 20130088204; 20130089793; 20130090900; 20130092866; 20130095351; 20130095392; 20130100563; 20130108899; 20130108930; 20130115520; 20130115529; 20130130069; 20130130121; 20130130128; 20130135110; 20130136981; 20130143090; 20130143129; 20130149567; 20130149602; 20130149605; 20130157147; 20130157149; 20130157152; 20130163148; 20130164611; 20130164612; 20130169238; 20130171340; 20130171502; 20130171512; 20130177814; 20130183579; 20130183580; 20130189575; 20130189579; 20130195805; 20130196223; 20130196235; 20130199936; 20130202920; 20130202955; 20130202956; 20130202959; 20130202967; 20130202973; 20130209860; 20130209869; 20130209870; 20130209887; 20130209897; 20130216899; 20130216907; 20130216908; 20130216918; 20130216920; 20130224576; 20130224583; 20130230772; 20130230773; 20130230779; 20130232772; 20130234074; 20130236750; 20130236766; 20130244102; 20130244107; 20130252090; 20130252101; 20130260222; 20130260229; 20130260232; 20130260254; 20130260255; 20130264999; 20130266827; 20130266846; 20130266858; 20130266866; 20130271089; 20130277599; 20130280592; 20130280621; 20130288084; 20130288113; 20130288120; 20130288138; 20130295439; 20130295461; 20130295465; 20130295492; 20130302650; 20130302679; 20130302697; 20130302702; 20130309527; 20130309549; 20130309564; 20130309571; 20130316248; 20130319870; 20130320582; 20130323585; 20130323595; 20130323605; 20130327648; 20130330609; 20130330637; 20130337304; 20130337335; 20130337338; 20130337339; 20130337340; 20130337341; 20130337343; 20130337346; 20130344360; 20130344383; 20130344391; 20130344392; 20140011081; 20140011088; 20140015160; 20140017549; 20140017559; 20140017568; 20140017573; 20140023932; 20140023934; 20140030609; 20140030610; 20140030623; 20140038059; 20140038060; 20140045015; 20140045016; 20140045017; 20140045019; 20140045020; 20140045021; 20140045022; 20140045065; 20140050910; 20140050972; 20140057168; 20140057169; 20140057172; 20140057173; 20140057179; 20140065479; 20140072837; 20140072843; 20140072877; 20140087214; 20140087250; 20140087251; 20140087257; 20140093780; 20140093787; 20140099560; 20140106219; 20140107326; 20140113202; 20140113203; 20140117940; 20140125292; 20140127567; 20140127575; 20140132220; 20140134499; 20140134501; 20140134521; 20140138591; 20140141336; 20140141337; 20140141340; 20140147741; 20140147752; 20140154546; 20140154557; 20140154559; 20140154587; 20140154590; 20140162130; 20140162131; 20140166929; 20140166939; 20140170303; 20140170475; 20140170482; 20140170498; 20140170503; 20140170524; 20140173300; 20140176074; 20140176076; 20140178759; 20140178770; 20140178772; 20140184162; 20140184172; 20140193712; 20140197801; 20140197805; 20140199585; 20140199599; 20140199600; 20140205905; 20140212752; 20140212763; 20140212770; 20140220417; 20140220422; 20140227432; 20140230887; 20140234693; 20140234705; 20140234711; 20140234712; 20140234713; 20140234727; 20140234732; 20140242445; 20140242453; 20140242469; 20140242474; 20140248521; 20140248537; 20140264198; 20140266075; 20140272132; 20140272489; 20140272531; 20140272553; 20140272558; 20140272567; 20140272568; 20140272574; 20140272576; 20140272577; 20140272578; 20140272579; 20140272580; 20140272583; 20140272591; 20140287305; 20140287325; 20140287330; 20140295268; 20140295270; 20140295290; 20140302354; 20140302400; 20140308562; 20140308583; 20140308585; 20140308588; 20140310951; 20140312269; 20140314948; 20140315072; 20140315097; 20140322579; 20140322602; 20140329120; 20140329131; 20140329150; 20140335406; 20140335410; 20140335411; 20140342200; 20140342228; 20140342240; 20140346618; 20140349182; 20140349186; 20140356708; 20140356735; 20140363735; 20140363746; 20140370380; 20140370387; 20140376160; 20140377635; 20140377667; 20140377668; 20150002162; 20150004444; 20150004480; 20150004482; 20150004488; 20150004495; 20150010460; 20150010784; 20150017541; 20150017543; 20150024279; 20150030856; 20150030939; 20150037675; 20150037686; 20150037690; 20150044517; 20150044533; 20150044556; 20150044571; 20150044573; 20150050535; 20150050564; 20150050565; 20150056488; 20150056507; 20150056509; 20150056514; 20150056516; 20150062687; 20150064568; 20150064578; 20150064580; 20150069307; 20150072225; 20150072232; 20150072247; 20150079477; 20150079483; 20150079484; 20150086876; 20150086877; 20150089797; 20150093631; 20150093647; 20150093653; 20150099165; 20150099184; 20150099185; 20150099187; 20150099191; 20150099192; 20150102257; 20150104701; 20150104712; 20150104716; 20150111078; 20150111099; 20150118558; 20150118565; 20150118572; 20150125595; 20150125752; 20150125759; 20150125761; 20150137030; 20150140206; 20150140427; 20150140434; 20150140446; 20150147624; 20150147642; 20150147645; 20150147662; 20150152566; 20150155546; 20150155557; 20150162139; 20150162588; 20150162603; 20150171414; 20150171426; 20150179976; 20150180001; 20150180023; 20150180087; 20150180249; 20150188125; 20150188191; 20150191841; 20150194702; 20150200390; 20150200422; 20150207147; 20150207174; 20150207176; 20150210044; 20150214529; 20150214573; 20150214577; 20150221936; 20150221983; 20150221987; 20150228980; 20150236343; 20150236372; 20150236378; 20150236380; 20150243972; 20150243973; 20150243987; 20150243988; 20150244041; 20150249247; 20150249262; 20150263342; 20150263379; 20150263543; 20150270552; 20150270573; 20150280219; 20150280229; 20150280267; 20150288031; 20150295241; 20150295275; 20150295276; 20150303481; 20150311509; 20150311525; 20150311564; 20150318543; 20150318570; 20150318572; 20150318578; 20150318580; 20150325843; 20150325852; 20150325880; 20150325882; 20150325884; 20150333310; 20150333315; 20150333370; 20150340679; 20150340739; 20150349338; 20150357646; 20150364747; 20150364748; 20150364755; 20150364791; 20150364794; 20150364795; 20150364796; 20150372296; 20150372305; 20150372346; 20150372349; 20150373831; 20150377977; 20150380355; 20150380731; 20150380772; 20150380777; each of which is expressly incorporated herein by reference in its entirety.

The SEI acts to prevent direct contact of the electrolyte molecules with the surface of the electrode, while allowing charge carrier transport. Because the surface of the electrodes is dynamic, a small portion of the SEI redevelops during each charge/discharge cycle from the electrolyte components in contact with the electrode interface with the bulk electrolyte. The cathode also has an SEI, though the cathode surface is less dynamic than the anode. Therefore, the electrolyte medium itself is involved in electrochemical reactions with the electrodes, and should be selected to provide stability under such conditions. The SEI may be an efficient free radical quencher, and thus once formed, provides an effective barrier that protects the bulk electrolyte from continuous degradation. See,

Sazhin, Sergiy V., Mason K. Harrup, and Kevin L. Gering. “Characterization of low-flammability electrolytes for lithium-ion batteries.” Journal of Power Sources 196.7 (2011): 3433-3438;

Harrup, Mason K., et al. “Unsaturated phosphazenes as co-solvents for lithium-ion battery electrolytes.” Journal of Power Sources 278 (2015): 794-801;

Xu, Kang, et al. “An attempt to formulate nonflammable lithium ion electrolytes with alkyl phosphates and phosphazenes.” Journal of The Electrochemical Society 149.5 (2002): A622-A626;

Gering, Kevin L., et al. Section IV. D. 3 for DOE 2013 Annual Report: Novel Phosphazene-Based Compounds to Enhance Safety and Stability of Cell Chemistries for High Voltage Applications (INL). No. INL/EXT-13-30529. Idaho National Laboratory (INL), 2013;

Rollins, Harry W., et al. “Fluorinated phosphazene co-solvents for improved thermal and safety performance in lithium-ion battery electrolytes.” Journal of Power Sources 263 (2014): 66-74; Choi,

Ji-Ae, Yongku Kang, and Dong-Won Kim. “Lithium polymer cell assembled by in situ chemical cross-linking of ionic liquid electrolyte with phosphazene-based cross-linking agent.” Electrochimica Acta 89 (2013): 359-364;

Gering, Kevin, M. Harrup, and E. Dufek. “Integrated Carbon-Reduced Battery Chemistries for Safer Alternative Li-Ion Cells.” 224th ECS Meeting (Oct. 27-Nov. 1, 2013). Ecs, 2013;

Harrup, Mason, Eric J. Dufek, and Kevin L. Gering. “Integrated Carbon-Reduced Battery Chemistries for Safer Alternative Li-Ion Cells.” Meeting Abstracts. No. 14. The Electrochemical Society, 2013;

Bieker, Georg, Martin Winter, and Peter Bieker. “Electrochemical in situ investigations of SEI and dendrite formation on the lithium metal anode.” Physical Chemistry Chemical Physics 17.14 (2015): 8670-8679;

Harrup, Mason K., et al. “Unsaturated phosphazenes as co-solvents for lithium-ion battery electrolytes.” Journal of Power Sources 278 (2015): 794-801;

Wu, Bingbin, et al. “An electrochemically compatible and flame-retardant electrolyte additive for safe lithium ion batteries.” Journal of Power Sources 227 (2013): 106-110;

Harrup, Mason K., et al. “Phosphazene Based Additives for Improvement of Safety and Battery Lifetimes in Lithium-Ion Batteries.” ECS Transactions 41.39 (2012): 13-25;

Zhang, Qing, et al. “Improved thermal stability of LiCoO2 by cyclotriphosphazene additives in lithium-ion batteries.” Chemistry Letters 34.7 (2005): 1012-1013;

Benson, Michael T., Mason K. Harrup, and Kevin L. Gering. “Lithium binding in fluorinated phosphazene trimers.” Computational and Theoretical Chemistry 1005 (2013): 25-34;

Zhang. Sheng Shui. “A review on electrolyte additives for lithium-ion batteries.” Journal of Power Sources 162.2 (2006): 1379-1394;

Cao, Xia, et al. “Novel phosphamide additive to improve thermal stability of solid electrolyte interphase on graphite anode in lithium-ion batteries.” ACS applied materials & interfaces 5.22 (2013): 1379-1394.

See also US Pat. Nos. and Patent Appl. Nos. U.S. Pat. Nos. 6,146,787; 6,544,690; 6,723,349; 7,008,564; 7,282,295; 7,282,296; 7,282,302; 7,285,362; 7,390,591; 7,491,458; 7,608,178; 7,645,543; 7,666,233; 7,691,289; 7,704,468; 7,781,108; 7,829,212; 7,838,144; 7,858,223; 7,864,397; 7,998,626; 8,048,571; 8,114,171; 8,182,943; 8,202,649; 8,293,398; 8,323,820; 8,334,075; 8,361,664; 8,389,147; 8,455,131; 8,459,213; 8,501,339; 8,529,867; 8,652,686; 8,652,692; 8,658,304; 8,671,684; 8,673,477; 8,709,679; 8,778,522; 8,828,573; 8,828,574; 8,828,575; 8,916,291; 8,932,771; 8,980,602; 8,986,638; 9,051,629; 9,061,261; 9,123,941; 9,136,568; 9,187,834; 9,187,835; 9,190,695; 9,200,375; 9,206,210; 9,257,720; 9,269,998; 9,287,573; 20040009404; 20050255385; 20080096056; 20100094042; 20120088162; 20130089793; 20130259776; 20140140912; 20140342240; 20150340739; each of which is expressly incorporated herein by reference in its entirety.

Conventional electrolytes have long been recognized as the significant “weak link” in lithium metal and lithium-ion batteries. While there have been significant improvements in the composition, processing, and fabrication of electrode materials over the past twenty years, electrolytes remain largely unchanged. Currently, they are composed of light organic fluids—chiefly small molecule compounds known as carbonates. While these fluids do their principal job, that is to transport lithium ions from one electrode to the other, they have some serious weaknesses that engender several major problems. This severe failing is greatly exacerbated, as there is an ever-increasing need for more energy dense systems that operate longer, with more reliability and greater safety.

Fluids have much higher lithium-ion mobility than true solids, affording the ability to operate at higher charge and drain rates than is currently available in solid-state materials. Many of the materials produced over the years that actually do exhibit acceptable drain rate behavior of “solid” electrolytes over a nominal temperature range (at least −20° to +50° C.) are actually a polymer or other solid scaffolding that has been imbibed with an entrained liquid (plasticizer) to increase performance. Typically, this liquid has been a small molecule organic species, very similar to the conventional electrolyte fluids mentioned above. However, though this approach has been shown to have limited utility, it also brings with it the same severe problems associated with such organic fluids: major safety problems, a lack of stability to higher voltage operations, and very short useful lifetimes before irreversible degradation.

Rechargeable lithium-ion batteries (LIBs) with high energy storage density are environmentally friendly and widely used in many fields. However, since these batteries use volatile and flammable liquid electrolytes there are safety issues such as poor thermal and chemical stability, potential for leakage of electrolyte, formation of lithium dendrites, and internal short circuits that remain unresolved. Compared to the traditional LIBs, all-solid-state lithium batteries (ASSLBs) replacing liquid electrolyte with solid electrolytes are designed to improve safety and to simplify battery architecture.

Conventional lithium-ion batteries include a positive electrode (or cathode as used herein), a negative electrode (or anode as used herein), an electrolyte, and, frequently, a separator. The electrolyte typically includes a liquid component that facilitates lithium-ion transport and, in particular, enables ion penetration into the electrode materials. In contrast, so-called solid-state lithium-ion batteries do not include a true liquid as one of their principal battery components. Solid-state batteries can have certain advantages over liquid electrolyte batteries, such as improvements in safety because the liquids used in liquid electrolytes are often volatile organic solvents. Solid-state batteries offer a wider range of packaging configurations because a liquid-tight seal is not as necessary as it is with liquid electrolytes.

Further, solid state batteries can more easily use lithium metal as the anode, thereby dramatically increasing the energy density of the battery as compared to the carbon-based anodes typically used in liquid electrolyte lithium-ion batteries. With repeated cycling, lithium metal can form dendrites, which can penetrate a conventional porous separator and result in electrical shorting and runaway thermal reactions. This risk is mitigated through the use of a solid nonporous polymer or other solid scaffold-based material, like condensed silicates or aluminates. as the electrolyte platform.

The electrolyte material in a solid-state lithium-ion battery can be a polymer. In particular, poly(ethylene oxide) (PEO) can be used in forming solid polymer electrolytes. PEO has the ability to conduct lithium ions as positive lithium ions are solubilized and/or complexed by the ethylene oxide groups on the polymer chain. Solid electrolytes formed from PEO can have crystalline and amorphous regions, and it is believed that lithium ions move preferentially through the amorphous portion of the PEO material. In general, ionic conductivities on the order of 1×10⁻⁶ S/cm to 1×10⁻⁵ S/cm at room temperature can be obtained with variations on PEO based electrolyte formulations. The electrolyte is typically formulated by adding an ionic lithium salt to the PEO in advance of building the battery, which is a formulation process similar to liquid electrolytes.

Solid-state batteries tend to have a substantial amount or degrees of interfaces among the different solid components of the battery. The presence of such interfaces can limit lithium ion transport and impede battery performance. Interfaces can occur (i) between the domains of active material in the electrode and the polymeric binder, (ii) between the cathode and the solid electrolyte, and (iii) between the solid electrolyte and the anode structure. Poor lithium ion transport across these interfaces results in high impedance in batteries and a low capacity on charge or discharge.

U.S. Patent Publication 2013/0026409 discloses a composite solid electrolyte with a glass or glass-ceramic inclusion and an ionically conductive polymer. However, this solid electrolyte requires a redox active additive. As another example, U.S. Pat. No. 5,599,355 discloses a method of forming a composite solid electrolyte with a polymer, salt, and an inorganic particle (such as alumina). The particles are a reinforcing filler for solid electrolyte and do not transport lithium. As yet another example, U.S. Pat. No. 5,599,355 discloses a composite solid-state electrolyte containing a triflate salt, PEO, and a lightweight oxide filler material. Again, the oxide filler is not a lithium ion conductor or intercalation compound.

More generally, ionically conductive polymers like PEO have been disclosed with the use of a lithium salt as the source of lithium ions in the solid electrolyte. For example, Teran et al., Solid State Ionics (2011) 18-21; Sumathipala et al., Ionics (2007) 13: 281-286; Abouimrane et al., JECS 154 (11) A1031-A1034 (2007); Wang et al., JECS, 149 (8) A967-A972 (2002); and Egashira et al., Electrochimica Acta 52 (2006) 1082-1086 each disclose different solid electrolyte formulations with PEO and a lithium salt as the source for lithium ions. Still further, Wang et al. and Egashira et al. each disclose inorganic nanoparticles that are believed to improve the ionic conductivity of the PEO film by preventing/disrupting polymer crystallinity.

Solid polymer electrolytes (SPEs) exhibit numerous advantages such as high energy density, light weight, mechanical flexibility, and high packing efficiency, which make SPEs preferred alternatives to liquid electrolytes and promising components in high-performance ASSLBs and other high-energy-density power sources. More recently, there has been ongoing research directed toward SPEs with high ionic conductivity, excellent mechanical behavior, good electrochemical stability to meet the application requirements of ASSLBs. To date, SPEs for ASSLBs have been based on poly(ethylene oxide) (PEO), poly(methyl methacrylate) (PMMA), and poly(vinylidene fluoride) (PVDF), to which are added various lithium salts. Among these SPEs, PEO-based polymer electrolytes are the most widely used and studied polymer electrolytes. However, PEO-based composites usually suffer from poor electrochemical stability and low conductivity (10⁻⁸-10⁻⁶ S/cm) caused by the high degree crystallization of polymer chains.

The addition of plasticizers is considered to be an efficient solution to suppress the high degree of crystallization in a polymer. However, liquid plasticizers will greatly detract from the mechanical properties of polymer electrolytes. These concerns prompted the development of a solid block copolymer electrolytes comprising blocks with sub-ambient glass transition temperatures (T_{g}), the blocks decorated with liquid-like brushes of PEO. An alternative approach is to replace the liquid plasticizer with a solid plasticizer to maintain the safety and mechanical properties. Owing to its presence as a single plastic phase between 35° C.-62° C., succinonitrile (SN) has received much attention for its potential use in ASSLBs as a solid plasticizer. Because SN shows trans-gauche isomerism involving rotation of molecules about the central C—C bonds, electrolytes composed of lithium salts dissolved in SN exhibit exceptionally high ionic conductivity at room temperature. In addition, the plasticity of SN can improve contact between the electrolyte and the electrodes. However, utility of such room temperature (RT) plasticizers is extremely limited as the operational temperature of the battery must be maintained above the minimum T_{g} of the material being employed.

Another strategy to improve transport properties and to enhance the mechanical strength of the SPEs is to incorporate ceramic fillers into a host PEO matrix. Many different oxides have been studied, including the classical TiO₂ and SiO₂ as well as the Li⁺-conductive Li_{1.3}Al_{0.3}Ti_{1.7}(PO₄)₃ and Li₁₀GeP₂S₁₂. The addition of filler to the PEO inhibits crystallization which in turn improves the ionic conductivity of the polymer electrolyte, while stabilizing its mechanical properties, and its ability to make good electrical contact with the electrode. However, at high filler content, the improvements in ionic conductivity (>10⁻⁴ S/cm) are realized only at elevated temperatures, thus limiting their utility at ambient or sub-ambient temperatures very similar to the effects of other solid-state incorporants as the SN above.

Owing to the expanding demand of commercial lithium-ion batteries (LIBs) with high-energy density and low cost, interest in the improvement of solid-based systems without the elevated temperature operation requirement is extremely high. Lithium metal anode with a high theoretical capacity of 3860 mAh g⁻¹ and lowest reduction potential (−3.045 V vs. the standard hydrogen electrode) has been a promising choice to improve the energy density of LIBs. However, the uncontrolled lithium dendrite formation during plating/stripping caused by non-uniform lithium nucleation and unstable solid electrolyte interface (SEI), results in potential risks such as short circuiting and burning, which have greatly impeded its large-scale application. Recently, numerous efforts have been devoted to solve these problems, including electrolyte additives, artificial SEI and 3D current collectors.

Despite these efforts varying from each other, most of them aim to improve the interfacial stability between electrolyte and Lithium metal anode. In this view, functional electrolytes which can stabilize the SEI and inhibit the growth of lithium dendrites seem particularly necessary. However, the volatile and combustible nature of liquid electrolytes hinder its development of next-generation Lithium Metal Batteries (LMBs) seriously. Different from the liquid electrolyte, the wide electrochemical window and non-flammable characteristics of the solid-state electrolyte greatly enhance the safety of the batteries, especially in pouch cells. The enhanced stability between solid-state electrolytes and a lithium metal anode makes it further considered as an effective strategy to operate the battery with a lithium metal anode, thus furthering the pursuit of high-energy-density and long lifespan LMBs.

Among the massive number of types of solid-state electrolytes, PEO based polymer electrolytes have attracted much attention due to their nature to solvate multifarious salts through interaction between its ether oxygens with Li-ion. However, low ionic conductivity, narrow electrochemical window and poor electrochemical stability with high energy electrodes make it, as a standalone, impossible for commercialization. A series of composite SPEs which combines an inorganic-based ion conductor have been reported to overcome these difficulties.

Unfortunately, the conductivity of these composite SPEs has not been improved sufficiently by controlling particles size or content, especially at room temperature. At the same time, the stability between cathode and SPEs also has a large determining effect on battery life. It is worth noting that a trace amount of liquid electrolyte can improve the interfacial stability between cathode and SPEs, but this method is so far unconducive to industrialization due to the inherent nature of the liquids employed. That is, when the limitations of the necessity for elevated temperatures of operation are removed, the failings of high volatility, high flammability and poor safety performance invariably return.

Alternatively, in addition to the use of these compounds (Pz, PA) as plasticizers in the electrolyte, these compounds may also be employed as catholytes and/or anolytes in specific types of energy storage systems. In addition to batteries, catholytes and anolytes have found use in supercapacitors as well. See Stucky, Galen D., and Xiulei Ji. “High energy capacitors boosted by both catholyte and anolyte.” U.S. Pat. No. 9,196,425, issued Nov. 24, 2015. The use of fluids in the electrodes themselves is not a novel concept and has been employed to improve ionic conduction within the electrodes themselves. The failing of most liquids so employed is the relative lack of electrochemical stability over a wide voltage range required for these liquids to function adequately. Compounds such as Pz and PA are however electrochemically stable over a very wide voltage range. These compounds can also serve in this capacity by selectively emplacing these compounds directly into the electrodes themselves to improve the ionic conductivity between the active electrode particles, thereby improving the overall performance of the battery/energy storage device.

One heavily investigated alternative is to use ionic liquids, which are salts in a liquid state at or near room temperature. Ionic liquids are also commonly studied as solvents or whole electrolytes due to their desirable properties, such as absence of a vapor pressure, high heat resistance and broad liquid temperature range, non-flammability, chemical stability, and higher ionic conductivity than all-solid counterparts. Unfortunately, ionic liquid systems, both alone and in tandem with other solid-state scaffolding, have proven to be unable neither of sustaining practical charge/discharge rates nor acceptable practical battery lifetimes.

See:

Bruce, P. G., S. A. Freunberger, L. J. Hardwick, and J. M. Tarascon, Nature Mater., 11 (2012).

Chen, Fei, Wenping Zha, Dunjie Yang, Shiyu Cao, Qiang Shen, Lianmeng Zhang, and Donald R. Sadoway. “All-solid-state lithium battery fitted with polymer electrolyte enhanced by solid plasticizer and conductive ceramic filler.” Journal of the Electrochemical Society 165, no. 14 (2018): A3558.

Choi, Jeong-Hee, Chul-Ho Lee, Ji-Hyun Yu, Chil-Hoon Doh, and Sang-Min Lee. “Enhancement of ionic conductivity of composite membranes for all-solid-state lithium rechargeable batteries incorporating tetragonal Li7La3Zr2O12 into a polyethylene oxide matrix.” Journal of Power Sources 274 (2015): 458-463.

Choi, Jeong-Hee, Chul-Ho Lee, Ji-Hyun Yu, Chil-Hoon Doh, and Sang-Min Lee. “Enhancement of ionic conductivity of composite membranes for all-solid-state lithium rechargeable batteries incorporating tetragonal Li7La3Zr2O12 into a polyethylene oxide matrix.” Journal of Power Sources 274 (2015): 458-463.F. Langer, I. Bardenhagen, J. Glenneberg, and R. Kun, Solid State Ionics, 291, 8 (2016).

Choi, Keun-Ho, Sung-Ju Cho, Se-Hee Kim, Yo Han Kwon, Je Young Kim, and Sang-Young Lee. “Thin, deformable, and safety-reinforced plastic crystal polymer electrolytes for high-performance flexible lithium-ion batteries.” Advanced Functional Materials 24, no. 1 (2014): 44-52.

Deviannapoorani, C., L. Dhivya, S. Ramakumar, and R. Murugan. “Synthesis of garnet structured Li₇₊xL3YxZr2+xO12 (x=0-0.4) by modified sol-gel method.” Journal of sol-gel science and technology 64, no. 2 (2012): 510-514.

Dunn, Bruce, Haresh Kamath, and Jean-Marie Tarascon. “Electrical energy storage for the grid: a battery of choices.” Science 334, no. 6058 (2011): 928-935.

Fan, L-Z., Y-S. Hu, Aninda J. Bhattacharyya, and Joachim Maier. “Succinonitrile as a versatile additive for polymer electrolytes.” Advanced Functional Materials 17, no. 15 (2007): 2800-2807.

Gray FM. Polymer electrolytes, RSC materials monographs. Cambridge: The Royal Society of Chemistry; 1997.

Gray FM. Solid polymer electrolytes-fundamentals and technological applications. New York: VCH; 1991.

Jung, Yun-Chae, Myung-Soo Park, Chil-Hoon Doh, and Dong-Won Kim. “Organic-inorganic hybrid solid electrolytes for solid-state lithium cells operating at room temperature.” Electrochimica Acta 218 (2016): 271-277.

Kamaya, Noriaki, Kenji Homma, Yuichiro Yamakawa, Masaaki Hirayama, Ryoji Kanno, Masao Yonemura, Takashi Kamiyama et al. “A lithium superionic conductor.” Nature materials 10, no. 9 (2011): 682-686.

Liu, Kai, Fei Ding, Jiaquan Liu, Qingqing Zhang, Xingjiang Liu, Jinli Zhang, and Qiang Xu. “A cross-linking succinonitrile-based composite polymer electrolyte with uniformly dispersed vinyl-functionalized SiO2 particles for Li-ion batteries.” ACS applied materials & interfaces 8, no. 36 (2016): 23668-23675.

Liu, Wei, Nian Liu, Jie Sun, Po-Chun Hsu, Yuzhang Li, Hyun-Wook Lee, and Yi Cui. “Ionic conductivity enhancement of polymer electrolytes with ceramic nanowire fillers.” Nano letters 15, no. 4 (2015): 2740-2745.

MacCallum JR, Vincent CA. Polymer electrolytes reviews-I. London: Elsevier; 1987.

Ni'mah, Yatim Lailun, Ming-Yao Cheng, Ju Hsiang Cheng, John Rick, and Bing-Joe Hwang. “Solid-state polymer nanocomposite electrolyte of TiO2/PEO/NaClO4 for sodium ion batteries.” Journal of Power Sources 278 (2015): 375-381.’ J. G. Kim, B. Son, S. Mukherjee, N. Schuppert, A. Bates, O. Kwon, M. J. Choi, H. Y. Chung, and S. Park, J. Power Sources, 282, 299 (2015).

Peng, Jun, Li-Na Wu, Jin-Xia Lin, Chen-Guang Shi, Jing-Jing Fan, Li-Bin Chen, Peng Dai, Ling Huang, Jun-Tao Li, and Shi-Gang Sun. “A solid-state dendrite-free lithium-metal battery with improved electrode interphase and ion conductivity enhanced by a bifunctional solid plasticizer.” Journal of Materials Chemistry A 7, no. 33 (2019): 19565-19572.

Plylahan, Nareerat, Manon Letiche, Maïssa Kenza Samy Barr, and Thierry Djenizian. “All-solid-state lithium-ion batteries based on self-supported titania nanotubes.” Electrochemistry communications 43 (2014): 121-124.

Prasanth, Raghavan, Vanchiappan Aravindan, and Madhavi Srinivasan. “Novel polymer electrolyte based on cob-web electrospun multi component polymer blend of polyacrylonitrile/poly (methyl methacrylate)/polystyrene for lithium ion batteries-Preparation and electrochemical characterization.” Journal of Power Sources 202 (2012): 299-307.

Scrosati B. Applications of electroactive polymers. London: Chapman Hall; 1993.

Sharma, Jitender Paul, and Vikas Bharti. “Role of Additives for High Performance Polymer Electrolytes.” In IOP Conference Series: Materials Science and Engineering, vol. 961, no. 1. p. 012005. IOP Publishing. 2020.

Soo, Philip P., Biying Huang, Young-Il Jang, Yet-Ming Chiang, Donald R. Sadoway, and Anne M. Mayes. “Rubbery block copolymer electrolytes for solid-state rechargeable lithium batteries.” Journal of the Electrochemical Society 146, no. 1 (1999): 32.

Srivastava, Samanvaya, Jennifer L. Schaefer, Zichao Yang, Zhengyuan Tu, and Lynden A. Archer. “25th anniversary article: polymer-particle composites: phase stability and applications in electrochemical energy storage.” Advanced Materials 26, no. 2 (2014): 201-234.

Stephan, A. Manuel. “Review on gel polymer electrolytes for lithium batteries.” European polymer journal 42, no. 1 (2006): 21-42.

Tsai, Chih-Long, Vladimir Roddatis, C. Vinod Chandran, Qianli Ma, Sven Uhlenbruck, Martin Bram, Paul Heitjans, and Olivier Guillon. “Li7La3Zr2O12 interface modification for Li dendrite prevention.” ACS applied materials & interfaces 8, no. 16 (2016): 10617-10626.

Wang, Weimin, Eongyu Yi, Anthony J. Fici, Richard M. Laine, and John Kieffer. “Lithium ion conducting poly (ethylene oxide)-based solid electrolytes containing active or passive ceramic nanoparticles.” The Journal of Physical Chemistry C 121, no. 5 (2017): 2563-2573.

Zhao, Yanran, Chuan Wu, Gang Peng, Xiaotian Chen, Xiayin Yao, Ying Bai, Feng Wu, Shaojie Chen, and Xiaoxiong Xu. “A new solid polymer electrolyte incorporating Li10GeP2S12 into a polyethylene oxide matrix for all-solid-state lithium batteries.” Journal of Power Sources 301 (2016): 47-53.

Zhao, Yanran, Zhen Huang, Shaojie Chen, Bo Chen, Jing Yang, Qiang Zhang, Fei Ding, Yanhua Chen, and Xiaoxiong Xu. “A promising PEO/LAGP hybrid electrolyte prepared by a simple method for all-solid-state lithium batteries.” Solid State Ionics 295 (2016): 65-71.

Zhou, Dong, Devaraj Shanmukaraj, Anastasia Tkacheva, Michel Armand, and Guoxiu Wang. “Polymer electrolytes for lithium-based batteries: advances and prospects.” Chem 5, no. 9 (2019): 2326-2352.

Zhou, Dong, Yan-Bing He, Ruliang Liu, Ming Liu, Hongda Du, Baohua Li, Qiang Cai, Quan-Hong Yang, and Feiyu Kang. “In situ synthesis of a hierarchical all-solid-state electrolyte based on nitrile materials for high-performance lithium-ion batteries.” Advanced Energy Materials 5, no. 15 (2015): 1500353.

U.S. and Foreign Patent Nos. U.S. Pat. Nos. 3,998,778; 4,020,830; 4,154,922; 4,214,968; 4,218,298; 4,288,588; 4,396,480; 4,413,041; 4,463,065; 4,547,428; 4,550,982; 4,585,714; 4,588,776; 4,599,284; 4,666,949; 4,684,558; 4,730,239; 4,734,184; 4,750,817; 4,764,378; 4,774,211; 4,791,374; 4,807,977; 4,814,060; 4,828,369; 4,830,780; 4,839,020; 4,839,322; 4,855,077; 4,867,541; 4,871,439; 4,871,442; 4,876,093; 4,883,497; 4,892,778; 4,925,752; 4,927,518; 4,940,465; 4,946,902; 4,960,761; 4,981,570; 4,983,322; 5,006,278; 5,011,588; 5,013,421; 5,023,133; 5,035,791; 5,057,565; 5,061,402; 5,063,081; 5,076,659; 5,078,856; 5,086,351; 5,102,526; 5,128,284; 5,171,478; 5,185,100; 5,200,051; 5,212,050; 5,217,827; 5,219,687; 5,227,285; 5,229,040; 5,232,631; 5,233,000; 5,240,790; 5,268,203; 5,273,965; 5,274,493; 5,276,079; 5,276,547; 5,286,365; 5,338,490; 5,352,270; 5,356,728; 5,358,801; 5,360,686; 5,378,405; 5,384,213; 5,385,679; 5,389,376; 5,393,621; 5,407,593; 5,409,786; 5,409,966; 5,415,746; 5,417,835; 5,421,983; 5,426,055; 5,436,091; 5,438,988; 5,441,831; 5,443,829; 5,453,171; 5,460,905; 5,462,566; 5,466,575; 5,472,808; 5,474,860; 5,484,670; 5,491,041; 5,501,150; 5,501,921; 5,505,200; 5,505,836; 5,506,073; 5,508,107; 5,510,209; 5,516,339; 5,518,839; 5,518,846; 5,520,180; 5,521,025; 5,522,978; 5,523,179; 5,529,860; 5,531,870; 5,532,077; 5,536,446; 5,536,599; 5,538,811; 5,540,741; 5,545,496; 5,548,055; 5,554,339; 5,558,961; 5,558,969; 5,561,007; 5,565,311; 5,569,560; 5,574,078; 5,578,399; 5,580,497; 5,580,680; 5,582,623; 5,584,893; 5,584,979; 5,595,837; 5,597,661; 5,599,355; 5,599,383; 5,601,947; 5,603,982; 5,607,566; 5,609,974; 5,616,152; 5,616,437; 5,622,813; 5,624,605; 5,626,795; 5,633,098; 5,635,138; 5,637,428; 5,639,437; 5,645,960; 5,650,398; 5,660,950; 5,665,490; 5,668,663; 5,670,270; 5,670,273; 5,670,557; 5,672,446; 5,674,561; 5,681,373; 5,685,319; 5,686,201; 5,690,702; 5,690,703; 5,693,442; 5,695,887; 5,698,338; 5,700,298; 5,700,300; 5,700,360; 5,705,084; 5,705,291; 5,712,220; 5,719,005; 5,720,780; 5,723,074; 5,724,187; 5,731,104; 5,731,117; 5,731,123; 5,738,691; 5,741,610; 5,744,264; 5,746,781; 5,749,029; 5,753,388; 5,756,230; 5,756,231; 5,759,215; 5,766,796; 5,773,194; 5,779,632; 5,780,182; 5,786,110; 5,789,108; 5,789,110; 5,798,190; 5,807,642; 5,814,420; 5,817,597; 5,824,120; 5,830,600; 5,834,136; 5,837,446; 5,837,454; 5,843,592; 5,846,558; 5,851,504; 5,853,750; 5,856,042; 5,858,573; 5,873,915; 5,874,018; 5,874,184; 5,882,721; 5,897,758; 5,902,697; 5,909,356; 5,911,862; 5,922,537; 5,928,812; 5,937,264; 5,939,235; 5,948,464; 5,948,590; 5,952,398; 5,958,201; 5,958,997; 5,962,169; 5,962,170; 5,965,319; 5,968,416; 5,972,054; 5,972,055; 5,985,117; 5,998,559; 6,146,787; 6,007,964; 6,010,799; 6,013,412; 6,015,638; 6,015,639; 6,017,647; 6,017,677; 6,022,640; 6,025,094; 6,033,804; 6,037,080; 6,040,085; 6,042,965; 6,042,987; 6,048,645; 6,051,339; 6,063,899; 6,066,425; 6,068,963; 6,071,539; 6,077,624; 6,078,778; 6,087,066; 6,096,479; 6,103,366; 6,103,419; 6,110,236; 6,110,640; 6,114,083; 6,117,590; 6,117,593; 6,117,613; 6,117,967; 6,120,941; 6,123,875; 6,132,929; 6,132,931; 6,136,472; 6,143,464; 6,148,503; 6,150,050; 6,150,051; 6,153,333; 6,153,352; 6,162,574; 6,165,646; 6,168,880; 6,168,885B1; 6,172,152; 6,174,621; 6,174,636; 6,177,230; 6,177,238; 6,177,417; 6,180,281; 6,187,157; 6,187,491; 62/857,770; U.S. Pat. Nos. 6,200,444; 6,200,704; 6,200,707; 6,214,061; 6,214,251; 6,214,518; 6,223,449; 6,225,002; 6,232,019; 6,235,432; 6,261,380; 6,268,087; 6,287,722; 6,306,509; 6,306,594; 6,309,778; 6,319,627; 6,331,375; 6,332,964; 6,333,133; 6,340,551; 6,340,554; 6,342,320; 6,344,426; 6,346,365; 6,352,796; 6,355,378; 6,355,380; 6,355,396; 6,358,646; 6,361,919; 6,368,746; 6,376,123; 6,376,168; 6,379,863; 6,379,969; 6,391,174; 6,391,175; 6,391,519; 6,397,749; 6,402,689; 6,402,795; 6,403,283; 6,409,867; 6,409,909; 6,410,203; 6,413,284; 6,413,285; 6,413,672; 6,413,676; 6,417,319; 6,420,083; 6,423,133; 6,423,462; 6,423,467; 6,432,581; 6,432,584; 6,440,633; 6,444,343; 6,444,356; 6,444,393; 6,451,482; 6,465,146; 6,467,156; 6,468,331; 6,468,697; 6,468,717; 6,488,961; 6,497,980; 6,497,989; 6,503,432; 6,503,691; 6,511,790; 6,514,656; 6,528,033; 6,537,725; 6,558,895; 6,566,014; 6,566,035; 6,569,811; 6,573,022; 6,576,397; 6,576,413; 6,576,415; 6,602,324; 6,602,645; 6,602,648; 6,605,237; 6,610,800; 6,630,271; 6,632,573; 6,641,977; 6,645,276; 6,645,675; 6,649,186; 6,653,042; 6,663,756; 6,664,006; 6,667,060; 6,667,106; 6,670,098; 6,673,496; 6,673,510; 6,677,091; 6,680,138; 6,686,125; 6,689,177; 6,692,896; 6,699,622; 6,699,623; 6,702,437; 6,702,961; 6,706,441; 6,706,445; 6,706,963; 6,709,800; 6,716,372; 6,716,548; 6,716,565; 6,720,112; 6,723,140; 6,723,470; 6,727,031; 6,730,281; 6,737,197; 6,740,470; 6,746,812; 6,749,984; 6,757,507; 6,770,392; 6,777,132; 6,780,562; 6,793,789; 6,794,123; 6,795,226; 6,797,117; 6,797,318; 6,803,141; 6,805,781; 6,811,577; 6,815,122; 6,821,675; 6,824,962; 6,828,065; 6,830,865; 6,833,225; 6,838,222; 6,841,330; 6,841,480; 6,844,137; 6,852,139; 6,855,229; 6,858,374; 6,869,547; 6,871,040; 6,872,492; 6,875,532; 6,878,492; 6,879,026; 6,881,359; 6,884,544; 6,886,240; 6,890,686; 6,902,858; 6,904,258; 6,906,842; 6,911,280; 6,911,299; 6,913,713; 6,913,855; 6,915,100; 6,919,166; 6,933,078; 6,935,237; 6,956,083; 6,960,335; 6,963,770; 6,963,771; 6,964,827; 6,972,167; 6,977,132; 6,980,763; 6,985,688; 6,986,967; 6,991,662; 7,285,362; 7,001,690; 7,004,592; 7,005,234; 7,010,340; 7,011,574; 7,011,898; 7,012,124; 7,022,264; 7,022,811; 7,026,072; 7,026,097; 7,029,810; 7,033,722; 7,037,636; 7,041,239; 7,049,043; 7,056,642; 7,060,206; 7,061,749; 7,067,243; 7,070,632; 7,070,706; 7,074,495; 7,074,610; 7,081,329; 7,083,709; 7,084,853; 7,087,346; 7,087,362; 7,094,301; 7,097,943; 7,101,643; 7,101,657; 7,105,270; 7,132,212; 7,132,226; 7,135,254; 7,140,298; 7,141,358; 7,144,678; 7,144,693; 7,147,995; 7,150,909; 7,150,938; 7,153,646; 7,162,781; 7,166,411; 7,171,252; 7,172,857; 7,177,578; 7,179,321; 7,183,017; 7,189,435; 7,189,478; 7,201,876; 7,214,448; 7,214,469; 7,217,489; 7,217,499; 7,223,356; 7,226,563; 7,226,715; 7,226,728; 7,230,321; 7,232,652; 7,238,451; 7,238,744; 7,244,526; 7,252,922; 7,258,961; 7,259,167; 7,270,869; 7,270,913; 7,270,915; 7,276,218; 7,279,241; 7,279,251; 7,279,266; 7,279,273; 7,282,295; 7,285,347; 7,300,561; 7,303,833; 7,303,857; 7,306,891; 7,306,893; 7,312,896; 7,332,108; 7,338,746; 7,341,815; 7,351,491; 7,354,531; 7,368,214; 7,371,497; 7,373,195; 7,381,424; 7,387,824; 7,399,393; 7,401,390; 7,402,374; 7,402,380; 7,407,741; 7,410,716; 7,419,751; 7,422,766; 7,422,823; 7,425,406; 7,432,309; 7,438,992; 7,446,084; 7,455,700; 7,462,424; 7,479,350; 7,479,535; 7,482,097; 7,485,359; 7,485,409; 7,491,262; 7,494,231; 7,498,095; 7,498,369; 7,504,473; 7,510,581; 7,517,564; 7,524,584; 7,524,605; 7,527,899; 7,531,261; 7,543,947; 7,550,098; 7,553,589; 7,557,433; 7,563,535; 7,569,328; 7,572,017; 7,572,789; 7,574,166; 7,575,709; 7,576,036; 7,586,663; 7,588,709; 7,595,085; 7,597,831; 7,601,771; 7,604,892; 7,608,376; 7,622,075; 7,622,667; 7,626,748; 7,628,944; 7,629,101; 7,645,540; 7,660,626; 7,674,875; 7,678,252; 7,678,863; 7,682,740; 7,682,753; 7,686,999; 7,687,217; 7,691,329; 7,695,580; 7,704,599; 7,704,639; 7,713,942; 7,713,955; 7,723,013; 7,727,438; 7,732,002; 7,740,984; 7,741,005; 7,744,835; 7,754,844; 7,756,568; 7,759,008; 7,763,384; 7,767,068; 7,767,332; 7,769,431; 7,771,061; 7,771,621; 7,771,628; 7,771,916; 7,776,429; 7,778,692; 7,781,358; 7,787,937; 7,790,112; 7,790,319; 7,796,205; 7,796,327; 7,799,777; 7,807,296; 7,807,333; 7,809,441; 7,824,806; 7,829,212; 7,851,103; 7,851,114; 7,851,133; 7,855,040; 7,862,976; 7,868,072; 7,871,169; 7,871,747; 7,884,042; 7,894,694; 7,897,082; 7,897,313; 7,901,810; 7,902,299; 7,906,006; 7,906,234; 7,910,286; 7,918,977; 7,922,809; 7,931,981; 7,932,299; 7,935,473; 7,938,984; 7,947,213; 7,947,392; 7,954,392; 7,959,791; 7,964,299; 7,968,271; 7,972,547; 7,972,759; 7,978,457; 7,988,885; 7,989,936; 8,034,490; 8,039,149; 8,039,175; 8,040,025; 8,055,322; 8,062,418; 8,067,402; 8,067,403; 8,080,330; 8,080,355; 8,088,743; 8,093,262; 8,101,332; 8,105,751; 8,114,214; 8,123,922; 8,126,554; 8,129,050; 8,129,052; 8,130,438; 8,133,377; 8,137,455; 8,137,846; 8,142,978; 8,142,983; 8,148,795; 8,158,226; 8,163,430; 8,173,343; 8,177,909; 8,182,943; 8,193,212; 8,202,291; 8,202,319; 8,216,727; 8,221,915; 8,221,916; 8,221,957; 8,227,156; 8,231,897; 8,236,447; 8,258,255; 8,262,896; 8,268,197; 8,268,381; 8,273,263; 8,284,539; 8,288,008; 8,292,911; 8,293,143; 8,293,398; 8,298,581; 8,304,115; 8,304,168; 8,318,342; 8,318,352; 8,318,353; 8,323,534; 8,323,838; 8,329,372; 8,332,028; 8,334,075; 8,338,031; 8,343,995; 8,354,202; 8,367,036; 8,373,559; 8,380,290; 8,399,172; 8,404,515; 8,409,746; 8,415,558; 8,425,822; 8,440,908; 8,445,142; 8,451,584; 8,455,154; 8,456,005; 8,465,629; 8,465,871; 8,491,861; 8,492,487; 8,496,943; 8,501,339; 8,511,841; 8,518,604; 8,541,078; 8,546,017; 8,557,907; 8,568,920; 8,571,659; 8,575,172; 8,576,542; 8,586,002; 8,591,945; 8,608,927; 8,610,992; 8,617,456; 8,623,964; 8,632,878; 8,632,904; 8,632,951; 8,641,910; 8,652,686; 8,673,067; 8,679,702; 8,685,934; 8,706,914; 8,706,915; 8,709,390; 8,728,686; 8,741,031; 8,747,525; 8,748,575; 8,749,869; 8,771,404; 8,772,390; 8,785,041; 8,808,407; 8,808,961; 8,822,492; 8,828,196; 8,828,580; 8,835,052; 8,841,034; 8,852,805; 8,853,236; 8,883,401; 8,883,743; 8,889,297; 8,890,130; 8,895,224; 8,932,400; 8,940,152; 8,940,446; 8,945,756; 8,968,961; 8,974,954; 8,986,903; 8,992,561; 9,077,046; 9,184,168; 9,000,117; 9,011,477; 9,011,729; 9,012,072; 9,029,023; 9,031,491; 9,032,876; 9,034,371; 9,034,519; 9,034,523; 9,037,067; 9,046,774; 9,054,394; 9,056,790; 9,058,935; 9,059,462; 9,061,940; 9,065,137; 9,067,401; 9,070,945; 9,072,583; 9,077,023; 9,090,729; 9,091,926; 9,093,706; 9,099,410; 9,114,602; 9,115,005; 9,123,941; 9,123,952; 9,125,945; 9,126,908; 9,142,863; 9,143,392; 9,144,964; 9,145,515; 9,160,035; 9,174,839; 9,177,721; 9,186,878; 9,188,868; 9,190,217; 9,203,070; 9,203,094; 9,207,537; 9,211,259; 9,212,286; 9,228,249; 9,240,574; 9,249,345; 9,252,461; 9,263,731; 9,263,758; 9,267,040; 9,269,950; 9,276,253; 9,296,158; 9,312,564; 9,327,978; 9,331,333; 9,337,435; 9,339,479; 9,343,609; 9,343,746; 9,350,017; 9,368,775; 9,368,778; 9,378,900; 9,379,368; 9,381,202; 9,397,337; 9,413,405; 9,417,480; 9,431,067; 9,431,655; 9,431,677; 9,437,899; 9,437,902; 9,446,262; 9,450,231; 9,457,512; 9,468,550; 9,468,649; 9,486,494; 9,490,463; 9,500,888; 9,504,658; 9,505,541; 9,545,446; 9,548,514; 9,553,326; 9,559,396; 9,572,773; 9,589,686; 9,595,399; 9,598,782; 9,599,273; 9,601,765; 9,601,780; 9,601,795; 9,615,917; 9,623,045; 9,627,147; 9,657,180; 9,660,241; 9,660,241; 9,662,049; 9,666,850; 9,673,483; 9,675,443; 9,680,102; 9,680,150; 9,684,219; 9,685,680; 9,690,195; 9,720,299; 9,728,775; 9,730,433; 9,730,894; 9,750,849; 9,757,384; 9,758,692; 9,765,043; 9,765,271; 9,766,528; 9,768,023; 9,770,443; 9,771,319; 9,782,416; 9,785,031; 9,791,760; 9,793,119; 9,793,542; 9,793,543; 9,798,214; 9,806,372; 9,808,418; 9,816,365; 9,823,535; 9,851,326; 9,859,062; 9,859,559; 9,864,250; 9,865,899; 9,874,539; 9,876,247; 9,882,193; 9,882,215; 9,887,406; 9,893,337; 9,893,337; 9,893,379; 9,895,248; 9,905,371; 9,914,861; 9,923,235; 9,941,547; 9,952,174; 9,954,213; 9,957,395; 9,958,504; 9,966,630; 9,969,891; 9,970,118; 9,970,711; 9,979,019; 9,985,313; 9,988,537; 9,990,578; 9,991,494; 9,991,503; 9,993,443; 9,997,270; 10,003,053; 10,008,742; 10,022,998; 10,028,966; 10,031,099; 10,034,947; 10,038,216; 10,041,886; 10,056,648; 10,058,557; 10,060,296; 10,061,177; 10,074,840; 10,085,865; 10,085,998; 10,090,078; 10,092,552; 10,099,419; 10,099,468; 10,103,377; 10,103,405; 10,105,356; 10,109,859; 10,109,884; 10,116,004; 10,122,002; 10,135,084; 10,143,665; 10,147,944; 10,156,764; 10,158,109; 10,158,109; 10,158,110; 10,158,118; 10,166,755; 10,177,387; 10,186,730; 10,199,677; 10,203,582; 10,205,194; 10,224,517; 10,224,562; 10,227,333; 10,230,112; 10,238,712; 10,241,071; 10,249,905; 10,254,344; 10,256,460; 10,256,473; 10,258,932; 10,264,995; 10,268,096; 10,276,869; 10,276,891; 10,290,895; 10,303,074; 10,305,090; 10,305,096; 10,305,141; 10,310,352; 10,322,597; 10,323,178; 10,323,215; 10,326,161; 10,328,037; 10,328,082; 10,331,003; 10,332,651; 10,342,848; 10,344,249; 10,347,434; 10,347,892; 10,347,904; 10,347,936; 10,347,937; 10,347,938; 10,350,100; 10,353,312; 10,358,584; 10,359,680; 10,361,405; 10,361,425; 10,361,455; 10,367,233; 10,374,204; 10,374,225; 10,392,301; 10,395,792; 10,400,341; 10,403,931; 10,403,932; 10,407,724; 10,411,288; 10,422,581; 10,424,794; 10,431,850; 10,431,858; 10,437,149; 10,439,251; 10,446,834; 10,446,845; 10,454,123; 10,456,408; 10,458,027; 10,459,308; 10,461,362; 10,468,718; 10,475,592; 10,482,367; 10,483,012; 10,490,845; 10,490,848; 10,490,848; 10,497,927; 10,509,317; 10,512,697; 10,519,328; 10,522,862; 10,529,971; 10,534,236; 10,535,870; 10,537,453; 10,539,851; 10,539,853; 10,543,178; 10,545,422; 10,548,859; 10,558,103; 10,559,398; 10,561,763; 10,563,918; 10,566,608; 10,566,652; 10,577,508; 10,581,114; 10,581,115; 10,586,965; 10,587,021; 10,591,493; 10,596,118; 10,601,049; 10,601,049; 10,605,762; 10,608,245; 10,608,249; 10,610,536; 10,617,545; 10,622,673; 10,634,638; 10,642,119; 10,642,120; 10,644,304; 10,644,314; 10,647,616; 10,649,337; 10,651,502; 10,655,024; 10,655,088; 10,658,674; 10,658,698; 10,668,049; 10,675,165; 10,689,542; 10,693,117; 10,698,287; 10,700,378; 10,707,493; 10,709,592; 10,723,835; 10,727,537; 10,729,592; 10,729,600; 10,731,010; 10,731,010; 10,732,477; 10,746,468; 10,749,214; 10,755,869; 10,759,209; 10,761,393; 10,761,394; 10,773,061; 10,786,489; 10,804,564; 10,804,565; 10,811,655; 10,818,965; 10,820,862; 10,826,041; 10,829,600; 10,833,301; 10,836,913; 10,840,500; 10,840,544; 10,840,545; 10,842,750; 10,847,842; 10,847,845; 10,852,266; 10,858,296; 10,858,467; 10,858,468; 10,862,101; 10,862,161; 10,862,165; 10,865,265; 10,874,537; 10,874,676; 10,883,957; 10,886,537; 10,892,474; 10,892,518; 10,892,518; 10,892,521; 10,894,057; 10,900,277; 10,900,925; 10,901,284; 10,903,484; 10,905,662; 10,909,437; 10,910,647; 10,916,753; 10,916,811; 10,921,673; 10,930,911; 10,935,862; 10,938,053; 10,942,465; 10,950,858; 10,950,882; 10,955,716; 10,964,934; 10,964,935; 10,967,043; 10,971,780; 10,975,238; 10,978,767; 10,983,409; 10,985,367; 10,988,489; 11,003,870; 11,013,741; 11,021,799; 11,031,631; 11,045,478; 11,049,666; 11,053,434; 11,061,231; 11,067,870; 11,069,896; 11,069,918; 11,069,920; 11,071,741; 11,075,376; 11,075,413; 11,079,650; 11,081,696; 11,081,727; 11,084,734; 11,091,390; 11,099,449; 11,108,031; 11,108,071; 11,114,714; 11,133,502; 11,133,527; 11,133,527; 11,139,121; 11,139,503; 11,158,880; 11,165,052; 11,165,096; 11,171,351; 11,171,357; 11,171,358; 11,174,516; 11,177,474; 11,183,734; 20010003639; 20010003643; 20010006677; 20010009129; 20010013273; 20010014420; 20010015334; 20010016290; 20010023039; 20010024757; 20010024766; 20010026900; 20010036592; 20010036598; 20010039895; 20010041294; 20020011165; 20020012834; 20020014616; 20020018936; 20020018938; 20020028387; 20020028404; 20020031710; 20020034688; 20020038762; 20020039687; 20020041443; 20020051929; 20020055058; 20020055066; 20020055074; 20020056388; 20020058217; 20020058219; 20020061484; 20020061820; 20020065332; 20020070112; 20020070374; 20020076617; 20020081522; 20020086214; 20020086233; 20020086238; 20020090738; 20020110735; 20020121206; 20020122967; 20020122977; 20020127456; 20020136979; 20020137991; 20020143122; 20020146654; 20020155067; 20020156207; 20020158342; 20020160271; 20020160295; 20020160300; 20020162456; 20020172889; 20020177074; 20020181971; 20020192553; 20030003369; 20030008228; 20030013019; 20030023001; 20030027027; 20030027049; 20030038610; 20030044714; 20030054245; 20030056301; 20030057610; 20030059682; 20030064288; 20030068575; 20030068586; 20030073001; 20030073034; 20030075066; 20030077514; 20030088971; 20030089229; 20030091904; 20030091947; 20030099909; 20030102584; 20030104295; 20030108799; 20030118635; 20030129492; 20030134196; 20030138721; 20030140959; 20030146965; 20030148160; 20030148209; 20030148614; 20030157434; 20030162121; 20030162129; 20030165736; 20030170542; 20030170566; 20030180610; 20030180623; 20030186061; 20030190526; 20030190527; 20030190528; 20030190549; 20030193110; 20030194653; 20030195396; 20030198885; 20030198890; 20030203136; 20030207089; 20030207185; 20030207202; 20030211383; 20030213691; 20030215714; 20030215715; 20030215719; 20030219685; 20030219960; 20030224192; 20030227663; 20030227664; 20030235683; 20030235795; 20040009426; 20040013943; 20040016632; 20040018444; 20040033428; 20040033934; 20040034253; 20040048129; 20040053101; 20040053137; 20040053149; 20040053163; 20040054041; 20040054126; 20040058176; 20040062805; 20040067434; 20040069655; 20040070724; 20040072987; 20040076456; 20040081887; 20040081894; 20040082668; 20040085556; 20040086307; 20040091294; 20040091295; 20040091296; 20040112529; 20040115572; 20040119187; 20040120730; 20040121263; 20040121273; 20040122178; 20040122192; 20040122475; 20040126686; 20040131934; 20040131971; 20040131972; 20040137326; 20040142287; 20040144511; 20040146325; 20040146765; 20040151985; 20040163949; 20040179861; 20040182306; 20040183055; 20040185236; 20040185344; 20040185371; 20040185374; 20040185384; 20040188045; 20040197654; 20040200991; 20040202924; 20040202937; 20040211319; 20040214084; 20040214105; 20040218346; 20040229156; 20040230115; 20040231984; 20040234893; 20040234906; 20040262571; 20040265484; 20040265663; 20040265664; 20040265669; 20040265695; 20050000803; 20050002704; 20050003311; 20050004155; 20050006237; 20050008772; 20050011760; 20050016458; 20050016578; 20050019583; 20050020448; 20050026091; 20050026092; 20050040374; 20050042510; 20050048399; 20050053840; 20050058905; 20050058936; 20050064331; 20050064332; 20050069735; 20050069745; 20050069811; 20050072690; 20050074674; 20050077604; 20050079415; 20050083577; 20050084755; 20050095401; 20050095482; 20050095483; 20050100782; 20050100825; 20050142483; 20050142493; 20050143517; 20050150383; 20050152974; 20050153643; 20050158383; 20050159364; 20050163837; 20050163842; 20050163843; 20050163858; 20050170255; 20050172843; 20050175894; 20050175943; 20050181253; 20050181283; 20050181946; 20050182236; 20050186469; 20050186476; 20050191349; 20050191428; 20050200124; 20050202159; 20050204943; 20050208235; 20050211294; 20050214675; 20050221194; 20050228247; 20050232990; 20050233221; 20050238961; 20050244697; 20050245653; 20050251033; 20050255026; 20050255383; 20050263021; 20050266150; 20050266184; 20050271596; 20050271939; 20050271941; 20050271976; 20050271981; 20050276856; 20050281961; 20060003213; 20060004192; 20060014078; 20060014640; 20060018937; 20060019163; 20060019169; 20060024612; 20060025307; 20060025748; 20060028730; 20060029752; 20060030652; 20060039975; 20060041075; 20060046043; 20060046149; 20060046216; 20060051418; 20060051532; 20060051701; 20060057358; 20060058188; 20060064857; 20060066005; 20060068321; 20060068341; 20060068344; 20060068345; 20060073376; 20060076051; 20060078790; 20060078797; 20060097428; 20060098389; 20060100278; 20060100323; 20060105255; 20060105258; 20060110691; 20060115768; 20060115776; 20060127651; 20060127826; 20060134488; 20060143901; 20060150846; 20060155127; 20060159972; 20060166048; 20060166137; 20060172234; 20060173401; 20060177732; 20060178500; 20060182703; 20060183019; 20060189776; 20060194112; 20060197255; 20060199115; 20060203322; 20060206026; 20060210932; 20060210933; 20060216194; 20060216637; 20060216660; 20060219294; 20060223002; 20060231987; 20060234031; 20060241407; 20060246351; 20060257728; 20060263688; 20060264454; 20060264455; 20060267167; 20060269485; 20060275857; 20060278526; 20060280795; 20070001153; 20070009800; 20070012189; 20070018141; 20070031766; 20070031767; 20070032381; 20070037058; 20070039500; 20070041074; 20070042044; 20070042265; 20070045896; 20070048605; 20070048607; 20070051403; 20070051620; 20070059619; 20070065724; 20070072135; 20070077518; 20070079867; 20070082290; 20070082291; 20070082303; 20070099118; 20070099132; 20070102294; 20070108420; 20070117006; 20070117033; 20070122596; 20070128255; 20070128491; 20070134546; 20070141468; 20070148418; 20070166570; 20070167340; 20070172719; 20070172739; 20070175020; 20070178232; 20070182068; 20070183066; 20070184388; 20070190414; 20070190425; 20070191351; 20070195399; 20070200477; 20070202342; 20070202431; 20070207361; 20070208130; 20070212644; 20070216060; 20070218256; 20070218404; 20070220721; 20070222107; 20070227886; 20070231723; 20070231739; 20070231740; 20070243466; 20070244093; 20070248520; 20070251570; 20070254104; 20070254224; 20070254994; 20070258731; 20070259265; 20070259271; 20070261218; 20070270674; 20070270675; 20070273070; 20070278092; 20070281230; 20070284761; 20070287095; 20070298350; 20080006322; 20080014526; 20080020127; 20080020277; 20080021212; 20080032071; 20080032143; 20080032225; 20080038447; 20080038611; 20080038641; 20080042315; 20080044652; 20080044763; 20080047677; 20080057419; 20080069617; 20080073810; 20080076026; 20080081118; 20080081256; 20080081274; 20080083452; 20080083626; 20080090138; 20080094684; 20080096079; 20080096118; 20080102340; 20080102391; 20080108501; 20080113261; 20080113287; 20080116908; 20080117563; 20080124645; 20080139525; 20080142753; 20080148977; 20080149501; 20080152826; 20080160324; 20080161665; 20080161746; 20080171288; 20080171647; 20080180781; 20080182176; 20080192407; 20080196828; 20080199221; 20080199772; 20080200667; 20080206161; 20080206486; 20080206670; 20080207581; 20080217587; 20080226989; 20080230393; 20080233516; 20080234367; 20080237928; 20080248361; 20080248395; 20080254384; 20080274194; 20080275327; 20080277632; 20080286008; 20080286685; 20080292953; 20080293852; 20080317847; 20090016953; 20090020907; 20090023027; 20090023085; 20090023090; 20090026662; 20090029179; 20090045545; 20090047601; 20090052017; 20090061314; 20090061332; 20090061346; 20090062264; 20090067032; 20090069740; 20090075048; 20090075176; 20090078307; 20090078917; 20090092903; 20090108487; 20090115096; 20090124875; 20090126601; 20090127736; 20090133746; 20090133922; 20090135344; 20090148525; 20090148526; 20090148777; 20090149451; 20090169994; 20090186272; 20090191266; 20090191458; 20090192077; 20090193648; 20090196930; 20090197135; 20090197172; 20090197176; 20090197178; 20090197182; 20090207555; 20090208806; 20090216910; 20090217979; 20090221523; 20090221925; 20090226817; 20090233178; 20090233221; 20090233229; 20090239817; 20090242113; 20090246688; 20090246693; 20090246696; 20090247778; 20090249558; 20090253014; 20090255826; 20090263724; 20090267260; 20090291369; 20090293748; 20090297441; 20090297741; 20090305090; 20090312358; 20100002282; 20100004262; 20100015225; 20100015538; 20100028429; 20100035093; 20100038243; 20100047537; 20100047656; 20100055613; 20100068628; 20100072428; 20100072643; 20100075255; 20100076553; 20100078837; 20100086823; 20100092870; 20100100031; 20100100116; 20100104643; 20100112195; 20100112431; 20100112444; 20100119881; 20100143803; 20100143824; 20100148392; 20100152340; 20100166866; 20100175993; 20100175994; 20100178589; 20100186220; 20100200051; 20100206613; 20100216032; 20100234416; 20100234478; 20100238534; 20100242766; 20100247870; 20100248418; 20100252428; 20100256360; 20100261983; 20100266899; 20100267924; 20100268078; 20100269892; 20100276632; 20100279844; 20100285352; 20100285374; 20100286791; 20100292268; 20100297508; 20100297527; 20100297531; 20100303701; 20100311879; 20100319424; 20100319762; 20100326500; 20100330455; 20110003070; 20110003123; 20110011459; 20110014522; 20110015300; 20110020226; 20110027579; 20110033772; 20110033776; 20110052986; 20110056563; 20110067600; 20110067603; 20110067605; 20110070153; 20110070154; 20110085965; 20110092961; 20110096388; 20110100805; 20110102528; 20110104189; 20110111335; 20110128137; 20110132461; 20110134411; 20110147680; 20110149366; 20110156996; 20110159345; 20110164349; 20110165482; 20110174179; 20110189287; 20110198837; 20110200876; 20110200910; 20110202134; 20110203489; 20110206974; 20110210010; 20110212359; 20110217656; 20110223487; 20110224245; 20110226145; 20110227243; 20110229765; 20110233532; 20110240064; 20110242730; 20110244320; 20110250626; 20110256454; 20110262520; 20110262629; 20110266503; 20110272280; 20110277818; 20110281150; 20110281171; 20110281172; 20110287094; 20110287316; 20110305948; 20110311436; 20110311899; 20120009481; 20120021358; 20120025982; 20120028132; 20120031303; 20120034155; 20120034156; 20120034157; 20120045696; 20120046420; 20120052411; 20120058949; 20120064410; 20120065221; 20120071403; 20120073474; 20120077113; 20120077739; 20120094176; 20120097194; 20120097251; 20120107392; 20120114089; 20120118762; 20120121944; 20120121974; 20120121976; 20120121991; 20120123049; 20120129045; 20120129045; 20120135317; 20120141779; 20120141864; 20120141885; 20120141886; 20120141887; 20120145047; 20120153220; 20120156552; 20120162600; 20120175551; 20120177994; 20120183852; 20120186976; 20120189959; 20120191124; 20120192861; 20120197231; 20120199995; 20120202114; 20120225359; 20120231346; 20120231368; 20120232576; 20120238554; 20120258351; 20120270112; 20120312696; 20120328959; 20130000488; 20130004852; 20130011449; 20130017432; 20130023688; 20130025292; 20130025458; 20130025459; 20130026409; 20130028942; 20130037809; 20130040942; 20130052709; 20130063802; 20130071748; 20130089660; 20130095390; 20130109790; 20130118550; 20130129700; 20130133934; 20130134357; 20130150809; 20130153821; 20130161600; 20130167756; 20130178407; 20130183570; 20130209861; 20130209893; 20130224624; 20130224632; 20130225806; 20130230782; 20130235323; 20130240800; 20130243506; 20130248376; 20130251401; 20130251674; 20130255516; 20130260257; 20130273406; 20130273437; 20130288138; 20130302682; 20130306276; 20130309291; 20130309301; 20130310424; 20130323571; 20130327249; 20130333790; 20130337022; 20130337338; 20130337340; 20130344397; 20130344440; 20130344444; 20140000101; 20140002788; 20140008746; 20140011100; 20140014403; 20140015173; 20140017576; 20140020585; 20140023903; 20140024792; 20140027730; 20140038881; 20140044786; 20140049879; 20140051006; 20140057153; 20140064810; 20140065538; 20140072882; 20140079873; 20140087214; 20140087271; 20140099537; 20140099552; 20140120185; 20140120247; 20140130708; 20140134504; 20140137945; 20140147789; 20140155566; 20140158536; 20140159668; 20140161721; 20140162129; 20140163664; 20140166929; 20140166930; 20140170465; 20140170470; 20140171581; 20140174923; 20140186699; 20140186719; 20140196631; 20140202349; 20140205905; 20140213671; 20140227548; 20140227614; 20140242124; 20140243871; 20140251172; 20140255772; 20140255792; 20140272600; 20140287001; 20140287321; 20140287323; 20140287342; 20140288381; 20140293514; 20140302398; 20140317315; 20140321030; 20140322302; 20140333872; 20140333874; 20140340821; 20140350001; 20140363726; 20140364425; 20150002098; 20150004522; 20150009605; 20150017088; 20150024251; 20150024325; 20150025243; 20150029641; 20150044288; 20150044581; 20150044612; 20150056520; 20150065606; 20150079480; 20150096464; 20150099188; 20150099190; 20150110951; 20150119529; 20150140432; 20150141767; 20150143806; 20150147677; 20150155551; 20150164826; 20150188187; 20150188189; 20150190258; 20150196543; 20150200413; 20150200420; 20150203686; 20150207140; 20150207173; 20150214540; 20150217923; 20150219589; 20150219974; 20150225571; 20150229000; 20150229005; 20150236323; 20150236341; 20150243971; 20150243978; 20150257911; 20150263325; 20150270521; 20150270860; 20150277202; 20150280234; 20150280250; 20150283287; 20150290771; 20150295227; 20150295228; 20150295236; 20150299461; 20150303451; 20150303455; 20150303465; 20150303466; 20150307401; 20150311500; 20150311515; 20150311517; 20150318547; 20150325830; 20150325884; 20150331293; 20150332141; 20150333331; 20150338367; 20150338368; 20150372277; 20150372317; 20150372347; 20150378176; 20150380759; 20160011441; 20160018335; 20160024333; 20160026055; 20160026081; 20160028063; 20160028070; 20160028114; 20160028114; 20160029998; 20160030624; 20160043405; 20160055983; 20160056382; 20160056500; 20160058322; 20160058786; 20160071552; 20160074553; 20160079572; 20160079631; 20160087306; 20160100970; 20160136178; 20160139475; 20160139476; 20160141716; 20160149202; 20160149222; 20160153099; 20160153273; 20160156081; 20160158261; 20160158280; 20160164102; 20160168086; 20160189884; 20160190555; 20160190575; 20160195491; 20160204476; 20160211498; 20160211506; 20160211546; 20160226042; 20160226114; 20160230022; 20160233469; 20160237069; 20160246153; 20160248631; 20160254500; 20160254514; 20160257864; 20160266460; 20160268571; 20160268639; 20160271297; 20160276706; 20160276706; 20160278662; 20160285077; 20160285088; 20160294005; 20160294006; 20160308244; 20160324804; 20160336593; 20160336618; 20160344008; 20160344008; 20160350565; 20160351879; 20160359193; 20160365606; 20160367530; 20160369209; 20160369210; 20160372743; 20160372787; 20160374967; 20160376437; 20170000843; 20170002264; 20170005309; 20170005356; 20170005362; 20170012287; 20170014780; 20170018781; 20170018802; 20170022112; 20170027168; 20170027728; 20170030856; 20170040607; 20170040635; 20170043931; 20170047611; 20170059957; 20170062830; 20170062830; 20170062873; 20170071795; 20170071862; 20170092932; 20170097551; 20170100395; 20170101719; 20170117536; 20170117583; 20170119587; 20170119588; 20170119589; 20170119596; 20170119597; 20170119598; 20170119600; 20170119669; 20170125841; 20170135968; 20170143732; 20170143789; 20170145573; 20170148578; 20170152359; 20170153060; 20170154767; 20170155169; 20170172778; 20170173178; 20170179464; 20170179521; 20170179522; 20170183512; 20170184535; 20170187067; 20170190167; 20170192332; 20170197400; 20170200954; 20170204124; 20170206997; 20170214021; 20170214084; 20170218138; 20170219904; 20170219905; 20170219906; 20170222254; 20170224706; 20170229733; 20170235203; 20170237105; 20170250438; 20170252352; 20170263976; 20170263981; 20170267869; 20170275475; 20170275770; 20170279101; 20170279113; 20170279125; 20170288276; 20170290693; 20170294636; 20170294674; 20170294678; 20170294678; 20170298682; 20170320350; 20170320351; 20170327698; 20170329196; 20170329225; 20170331092; 20170336691; 20170338056; 20170346060; 20170346129; 20170346135; 20170357136; 20170368228; 20170370948; 20170373300; 20180003667; 20180009212; 20180013171; 20180015115; 20180021344; 20180022656; 20180036245; 20180040888; 20180040894; 20180040895; 20180042923; 20180043656; 20180045465; 20180049901; 20180055813; 20180062212; 20180064569; 20180066371; 20180069263; 20180076480; 20180079910; 20180085423; 20180088426; 20180088430; 20180088431; 20180090766; 20180090784; 20180094858; 20180108937; 20180110640; 20180114977; 20180115016; 20180115017; 20180117942; 20180136160; 20180137984; 20180138494; 20180147221; 20180149975; 20180151302; 20180157174; 20180159182; 20180164650; 20180166671; 20180166672; 20180166689; 20180173070; 20180183017; 20180183094; 20180191028; 20180191035; 20180198170; 20180205117; 20180244631; 20180246171; 20180254446; 20180257027; 20180260673; 20180261877; 20180272113; 20180275091; 20180277890; 20180280405; 20180282046; 20180284049; 20180287150; 20180294460; 20180294523; 20180301754; 20180311989; 20180314152; 20180316018; 20180321175; 20180321590; 20180323471; 20180325894; 20180325917; 20180326090; 20180329327; 20180330844; 20180331361; 20180334575; 20180342733; 20180342764; 20180347406; 20180351165; 20180355116; 20180355116; 20180355194; 20180358620; 20180364540; 20180364541; 20180366710; 20180375149; 20190000655; 20190000778; 20190006711; 20190006713; 20190011795; 20190020059; 20190023981; 20190025283; 20190030012; 20190043639; 20190044134; 20190044180; 20190044186; 20190048223; 20190049869; 20190051938; 20190054076; 20190058210; 20190060333; 20190067675; 20190067693; 20190074543; 20190076451; 20190088958; 20190088969; 20190091249; 20190094694; 20190103627; 20190103630; 20190105327; 20190109311; 20190111008; 20190112469; 20190115118; 20190117665; 20190123340; 20190123351; 20190131617; 20190131660; 20190140261; 20190146221; 20190148756; 20190157657; 20190157664; 20190157670; 20190157724; 20190173130; 20190176459; 20190177238; 20190198836; 20190198837; 20190204261; 20190205717; 20190207251; 20190207252; 20190207270; 20190212652; 20190221805; 20190221879; 20190221879; 20190227401; 20190229316; 20190235028; 20190235339; 20190235341; 20190235342; 20190235406; 20190237734; 20190245155; 20190245234; 20190247050; 20190249116; 20190252664; 20190252682; 20190252683; 20190252718; 20190255870; 20190260027; 20190260071; 20190260073; 20190262322; 20190262420; 20190267634; 20190271893; 20190276662; 20190278147; 20190280274; 20190280331; 20190285958; 20190292098; 20190305266; 20190309433; 20190311859; 20190312269; 20190312272; 20190319270; 20190324338; 20190324339; 20190324340; 20190334204; 20190337817; 20190338430; 20190341165; 20190346733; 20190358179; 20190361311; 20190363337; 20190363398; 20190365277; 20190372155; 20190372158; 20190372164; 20190374163; 20190374213; 20190379034; 20190379085; 20190379085; 20190389812; 20190393573; 20200003494; 20200006806; 20200011936; 20200011937; 20200011938; 20200014053; 20200019035; 20200026139; 20200033413; 20200038640; 20200040469; 20200041899; 20200044219; 20200051710; 20200054709; 20200057017; 20200057307; 20200062973; 20200067120; 20200067134; 20200075960; 20200076004; 20200089070; 20200100925; 20200100926; 20200102663; 20200112050; 20200112050; 20200112055; 20200116664; 20200124998; 20200127264; 20200127324; 20200136127; 20200136164; 20200136185; 20200136191; 20200140297; 20200143999; 20200144592; 20200144627; 20200144628; 20200144633; 20200144635; 20200144648; 20200144653; 20200144654; 20200144665; 20200144667; 20200147032; 20200147100; 20200152396; 20200153037; 20200153039; 20200153041; 20200165271; 20200165439; 20200168876; 20200168945; 20200173955; 20200174334; 20200176743; 20200176752; 20200182549; 20200189306; 20200194807; 20200194826; 20200194831; 20200194846; 20200198389; 20200199345; 20200199674; 20200203747; 20200203762; 20200203763; 20200212383; 20200212484; 20200212491; 20200212492; 20200216361; 20200220202; 20200222391; 20200222417; 20200223216; 20200226999; 20200235374; 20200235409; 20200235410; 20200235420; 20200235420; 20200237772; 20200241376; 20200243870; 20200251714; 20200253767; 20200255959; 20200255962; 20200255963; 20200259186; 20200259211; 20200259217; 20200261381; 20200266442; 20200266478; 20200268574; 20200274192; 20200276135; 20200276166; 20200277510; 20200279144; 20200280047; 20200280068; 20200280093; 20200285125; 20200287245; 20200287245; 20200303135; 20200306264; 20200313135; 20200313183; 20200316605; 20200321623; 20200333076; 20200335768; 20200335814; 20200335816; 20200335823; 20200335826; 20200338076; 20200340939; 20200350616; 20200350616; 20200353741; 20200354509; 20200356002; 20200356008; 20200358081; 20200358081; 20200358088; 20200358088; 20200358106; 20200358107; 20200358137; 20200358140; 20200363692; 20200365953; 20200373552; 20200377690; 20200381712; 20200381775; 20200388796; 20200388811; 20200388826; 20200388874; 20200395628; 20200399212; 20200401008; 20200403190; 20200405704; 20200406728; 20200407329; 20200407543; 20200411830; 20200411877; 20210002493; 20210005858; 20210005926; 20210013460; 20210020886; 20210020912; 20210020932; 20210020944; 20210020944; 20210020978; 20210020978; 20210020986; 20210020986; 20210020992; 20210022683; 20210024688; 20210024710; 20210026140; 20210026262; 20210026264; 20210027954; 20210028444; 20210028499; 20210033561; 20210036291; 20210041757; 20210046009; 20210050575; 20210057699; 20210057752; 20210066687; 20210066757; 20210069165; 20210077474; 20210083317; 20210083320; 20210091369; 20210091419; 20210091424; 20210093569; 20210093570; 20210098807; 20210102063; 20210104737; 20210109416; 20210111382; 20210113600; 20210114991; 20210115220; 20210116827; 20210116860; 20210119189; 20210119249; 20210135193; 20210135272; 20210135272; 20210141281; 20210145445; 20210146401; 20210151748; 20210151794; 20210151795; 20210159547; 20210163393; 20210167383; 20210167417; 20210167471; 20210170630; 20210175491; 20210175517; 20210175540; 20210184241; 20210184254; 20210184260; 20210184269; 20210189137; 20210194017; 20210194045; 20210202929; 20210202947; 20210202980; 20210202983; 20210202990; 20210203024; 20210203025; 20210205304; 20210206188; 20210210818; 20210210819; 20210212964; 20210218048; 20210221117; 20210223710; 20210226209; 20210226250; 20210232013; 20210234153; 20210234166; 20210238202; 20210240048; 20210242449; 20210249674; 20210253535; 20210257658; 20210280908; 20210280908; 20210280916; 20210284805; 20210296737; 20210301197; 20210305554; 20210305579; 20210305664; 20210305665; 20210309947; 20210313122; 20210313619; 20210313653; 20210317296; 20210320326; 20210320327; 20210320331; 20210320332; 20210320380; 20210322434; 20210323931; 20210327655; 20210328260; 20210332016; 20210332489; 20210336263; 20210336265; 20210336273; 20210340011; 20210344040; 20210346399; 20210346951; 20210347686; 20210347739; 20210351436; 20210357719; 20210359337; 20210363341; 20210367237; 20210367298; 20210371296; 20210375558; 20210379142; AU2020204698; BR102020002828; CA2181822; CA3043497; CN101507023; CN102272990; CN102272990; CN102593419; CN102593419; CN102668221; CN103026542; CN103178296; CN103178296; CN103222100; CN103222100; CN103509153; CN104466239; CN104604016; CN104604016; CN105811006; CN105811006; CN106165160; CN106165160; CN106463704; CN106463704; CN107004834; CN107078256; CN107112503; CN107534148; CN107534158; CN107658500; CN107665966; CN107851847; CN108140440; CN108140440; CN108701506; CN108963334; CN109401693; CN109526240; CN109690862; CN109776423; CN109776423; CN110168781; CN111048827; CN111095653; CN111183543; CN111279526; CN111354974; CN111540948; CN111656594; CN111969247; CN112397762; CN112421046; CN112500673; CN112514132; CN112786969; CN112805848; CN112979875; CN113016104; CN113471527; CN113508494; CN113544904; CN1191651; CN1199311; CN1411616; DE102014206040; DE102014226394; DE102016100472; DE102017211413; DE102018119757; DE102018217520; DE102018222593; DE102020133443; DE112018004420T5; EP0397523; EP1166378; EP1249049; EP1912275; EP2477259; EP2648265; EP2874228; EP2933869; EP3018751; EP3125339; EP3201976; EP3201977; EP3545573; EP3602657; EP3686982; EP3745517; EP3819960; EP3843193; EP3848949; EP3906589; EP3906590; H1546H; IN2007DE01572; IN2012DE02278; IN2014DN10019; IN202017023069; IN202024001679; IN202037036335; IN202117012699; JP2002534775; JP2003518709; JP2008084838; JP2008270201; JP2010157473; JP2011011928; JP2011014298; JP2012009209; JP2013118129; JP2013214494; JP2014513857; JP2015525452; JP2016042416; JP2016511521; JP2017191766; JP2019512841; JP2019517722; JP2019526893; JP2019536235; JP2020115459; JP2020534647; JP2021077611; JP2021500715; JP2021532544; JP5000408; JP5122712; JP5256816; JP5462949; JP6042533; JP6197944; JP6198380; JP6337683; JP6350872; JP6533305; JP6960727; JPWO2012039500; JPWO2014092121; JPWO2015146857; JPWO2016047360; JPWO2019146137; KR100473352; KR100497251; KR100906251; KR101422908; KR101558861; KR101586199; KR101849975; KR101960581; KR102188558; KR102225174; KR102315183; KR20040043414; KR20050023123; KR20080027503; KR20120083081; KR20130111833; KR20130119922; KR20140008264; KR20150088773; KR20150095818; KR20160128355; KR20170056693; KR20170116464; KR20180005173; KR20180063148; KR20180077083; KR20180118750; KR20190042542; KR20190045206; KR20190077553; KR20190088332; KR20190113605; KR20190124519; KR20200041165; KR20200104891; KR20210013476; KR20210056881; KR20210057776; KR20210110692; KR20210110693; KR20210148257; RE41579; RU2727523; SE518109; TW201327967; TW201411918; TW201439172; TW201813176; TW201924118; TW201935747; TW202015279; TW202030909; TW202036960; TW202044646; TW202123524; TWI455388; TWI485906; TWI487738; TWI725654; WO2000041258; WO2001047047; WO2009049220; WO2010111308; WO2012039500; WO2014010936; WO2014092121; WO2015058187; WO2015146857; WO2016047360; WO2016050329; WO2016050331; WO2016097090; WO2016200559; WO2016205653; WO2018052371; WO2018098249; WO2018183771; WO2019055303; WO2019146137; WO2019190126; WO2019208959; WO2020076099; WO2020142702; WO2020142708; WO2020142783; WO2020176905; WO2020206097; WO2021011438; WO2021011439; WO2021086485; WO2021106001; WO2021140149; and WO2021174186.

### SUMMARY OF THE INVENTION

Most polymer electrolytes depend upon a plasticizer to bring ionic conductivity up to acceptable levels for incorporation into practical lithium-ion cells. These plasticizers are typically organic fluids, such as those already employed as liquid electrolytes. The plasticized solid electrolytes may be gel polymer electrolytes. The advantages of these gel polymer electrolytes include reduction in the potential for internal shorting, reduction in electrolyte bulk leakage if the cell casing is compromised, and a potentially a better interface at the electrode surface than is afforded by liquid electrolytes. These gel polymer electrolytes have been extensively studied, but along with the advantages of a solid matrix they currently bring along the inherent disadvantages associated with these typical of organic fluid electrolytes. Namely these disadvantages are: 1) high flammability of the liquid organic electrolyte leading to extreme safety problems, especially in upset conditions; 2) high volatility of the organic liquid, leading to swelling and internal pressure problems; 3) an inherent lack of thermal stability, leading to a forced narrow temperature range of operation and short cell lifetimes; 4) a narrow window of electrochemical operation, which precludes the use of emerging high voltage electrodes and; 5) potential incompatibility with emerging electrode materials of interest, particularly lithium metal as an anode.

Plasticizers used in such gel polymer electrolytes must possess certain requisite properties to fulfill this role in gel electrolytes. First, they must be good conductors of lithium ions or improve the ionic conductivity of host polymers, as without either of these, plasticizers will only fulfill the lowest power functions. Second, they must be compatible with all of the balance of cell components, which include lithium salts, host polymer/composite matrices, cathode materials (oxidizing) and anode materials (reducing), including lithium metal. Third, they must be stable in an operational battery environment under strong electric fields. To this end, plasticizers must enhance the ionic conductivity of a host polymer. Many polymers have been studied as their chemical and mechanical properties fulfill the proper role in these gel electrolytes. The most studied include: poly(ethyleneoxide) (PEO), poly(propylene oxide) (PPO), poly(acrylonitrile) (PAN), poly(methyl methacrylate) (PMMA), poly(vinyl chloride) (PVC), poly(vinylidene fluoride) (PVdF), poly(vinylidene fluoride-hexafluoro propylene) (PVdF-HFP).

Similarly, many different organic fluids have been evaluated as plasticizers and many have been found to incrementally improve upon polymer ionic conductivity. However, as stated above, organic plasticizers bring along all of the downsides of such organic fluids. It is clear that the susceptibility of the organic plasticizer to degradation becomes the weakest link in enabling the widespread, safe use of such electrolyte systems.

What is needed is a plasticizer, e.g., an inorganic plasticizer, that brings along all of the requisite properties needed to function as a practical plasticizer for gel polymer electrolytes, while eliminating the drawbacks of the current generation of organic plasticizers.

As used herein, an inorganic plasticizer is a compound having a core structure that does not have carbon-carbon bonds, though substituent ligands may be organic.

The inorganic fluids based upon phosphorus-nitrogen compounds that have been recently developed and continue to exhibit great promise as liquid electrolytes can also function as plasticizers for polymer electrolyte systems. In addition, these inorganic liquids possess all of the requisite qualities to serve as non-aqueous electrolytes, with significant benefits over analogous organic liquid electrolytes, without the significant drawbacks of organic electrolytes. First, they are non-flammable. Second, they are non-volatile, and, for example, have a vapor pressure less than 10 mm, e.g., less than 1 mm or 1 mm Hg at 25° C. Third, they operate over much wider temperature ranges as well as much wider electrochemical ranges while remaining stable. Finally, these inorganic plasticizers have been proven to be compatible with a wide range of polymer and composite materials such as those associated with the host matrices of polymer gel electrolytes. This makes them excellent inorganic plasticizers for incorporation into gel-based electrolytes. In addition, these inorganic compounds are hydrolytically stable, compatible with/easily solubilized in a wide variety of solvents that are typically employed in the formation of gel electrolytes and are easy to incorporate into gel polymers using the wide variety of fabrication methods typically employed to form such systems. The resultant gel electrolytes would have the benefits of typical gel electrolytes without the significant downsides enumerated above. The intrinsic advantages of the inorganic plasticizing fluids under the most severe set of battery operating conditions and cell electrochemical environment would improve the stability as well as the performance gel electrolytes compared to conventional systems with organic plasticizers, while still performing the basic function of said gel electrolytes.

Inorganic fluids are superior to ionic liquids in several key aspects. Ionic liquids are chiefly organic in nature and as such are also subject to some of the same safety issues as more conventional organic electrolytes. Further, as ionic liquids possess a formal negative charge in each molecular pair, problems with too high an association energy with lithium ions severely adversely affects the performance of such systems. Finally, ionic liquids have a natural tendency towards high self-association leading to relatively high melting points and very poor low temperature performance. In contrast, the inorganic fluids according to the present technology are neat fluids that are neutral, and not ionic.

The present inorganic fluids may be used with lithium metal anodes. Therefore, the present inorganic fluids may be used as plasticizers for gel polymers in cells with lithium metal anodes. Further, the high degree of compatibility may also lead to their use as anolytes. Similarly, these inorganic fluids are also highly compatible with a wide variety of cathodes (NMC, NCA, LiFePO, etc.) which could lead to their use as catholytes in lithium batteries. More generally, the inorganic fluids may be localized in a part of the cell, and therefore need not be distributed throughout the cell.

The three most significant challenges to the use of lithium metal as an anode are: electrolyte solvent stability to lithium metal, overall safety, and dendrite suppression.

The present inorganic fluid electrolyte solvents are beneficial in overcoming all three of these issues, whether these are employed as electrolyte solvents or as plasticizers for polymer and polymer composite electrolytes.

Further, this inorganic fluid has been proven to make superior electrode/electrolyte interfacial layers through the incorporation of inorganic component(s) within such layers upon formation. Stability of the present inorganic fluids has been demonstrated in the lab. Lithium metal can be stored completely immersed in these inorganic fluids indefinitely (tests ran for ˜1 year) with no degradation of the fluid. Nor was there any effect upon the metallic lithium as evidenced by no tarnishing of the metal surface. Further, cyclic voltammetry experiments have shown that these inorganic fluids are electrochemically tolerant over a much wider potential range than conventional organic electrolyte solvents. This wider electrochemical window of stability favors extending cell cycle life and enabling higher rate capability, both during use and especially during recharge times. All of these advantages of the inorganic fluid apply to its use as a plasticizer for polymer and polymer composite electrolytes.

The present inorganic fluids are non-volatile. As it is the gasses of volatilized electrolyte solvents that ignite, the demonstrated depression of the vapor pressure at all temperatures of hybrid organic/inorganic electrolytes ameliorates this problem. Further, the present inorganic fluids are also non-flammable. As such, not only will the inorganic component of the electrolyte solvent blend never burn, it has been demonstrated that the flash point of hybrid organic/inorganic electrolyte solvents significantly increases with increasing inorganic character of the hybrid. Having higher flash points in such hybrid organic/inorganic blends make it much more difficult for a flame event to occur, even if the cell housing is breached. All of these advantages of the inorganic fluid apply to its use as a plasticizer for polymer and polymer composite electrolytes.

While the present inorganic fluids may be mixed with some percentage of conventional organic fluids in a battery, they have demonstrated much higher stability to not only lithium metal but also a greater stability at extreme voltages where conventional organic fluids rapidly decompose. This decreased electrolyte decomposition at the anode surface would reduce physical irregularities from forming at the Li metal surface, particularly during the plating process upon recharge. Prevention of such irregularities leads to a more even, uniform plating of the lithium metal. This aids in the suppression of surface anomalies which should in turn lead to the suppression of one of the main root causes of dendrite formation. All of these advantages of the inorganic fluid apply to its use as a plasticizer for polymer and polymer composite electrolytes.

An exemplary material usable according to an embodiment of the invention is triethoxy tri-trifluoroethoxy phosphazene (FM2). It is known that FM2 is compatible with lithium metal, and is also compatible with a wide variety of cathode materials, both conventional and high energy materials. This inorganic fluid is also an exemplary use as a plasticizer for polymer and polymer composite electrolytes.

A conventional cathode is LiNiₓMn_{y}Co_{z}O₂ (NMC). The high-nickel NMC811 yields substantially higher capacity than other the low Ni-content NMCs for the same upper cut-off voltage. So, these inorganic liquids will function as compatible electrolyte solvents and as plasticizers for polymer and polymer composite electrolytes that use these Ni-based cathode active materials.

Various lithium conducting salts may be used, e.g., lithium hexafluorophosphate (LiPF₆) and lithium bis(trifluoromethanesulfonyl)imide (LiTFSI), etc. LiPF₆ is ubiquitously used in commercial Li-ion batteries. Despite its wide adoption in Li-ion batteries, LiPF₆ is sensitive to water/moisture, with which it undergoes a hydrolysis that produces hydrofluoric acid (HF). The low thermal stability of LiPF₆ also leads to the formation of fluoro-organic species at elevated temperatures. Both drawbacks pose safety and health risks in the event of battery failure. As an alternative to LiPF₆, LiTFSI demonstrates improved thermal stability and reduced moisture sensitivity. So, these inorganic liquids will function as compatible electrolyte solvents and as plasticizers for polymer and polymer composite electrolytes that use these and any other electrolyte salt in the electrolyte system. Co-solvents may be used to reduce the viscosity of FM2 to achieve the desired rate performance, either as a solvent or as a plasticizer. Both ether-based (non-fluorinated) and fluorinated solvents may be used as co-solvents with FM2.

The ether-based 1,2-dimethoxyethane (monoglyme) and 1-methoxy-2-(2-methoxyethoxy)ethane (diglyme) solvents possess low viscosity and have demonstrated better reductive stability against lithium metal than the conventional carbonate-based solvent. Ethyl (1-fluoroethyl) carbonate (FDEC) is a common co-solvent that has been used to form a stabilized SEI with lithium metal. The linear FDEC also suppresses the corrosion of the aluminum current collector. Methyl (2,2,2-trifluoroethyl) carbonate (FEMC) exhibits high stability against high voltage oxidation and passivates the cathode surface to prevent transition metal ion dissolution.

The reductive instability against lithium metal of the ether-based solvents might be overcome with the FM2 co-solvent. These co-solvents are appropriate choices as co-plasticizers for polymer electrolytes, as well. In addition, there are many small molecule electrolyte solvents in use for conventional battery chemistries that would complement the inorganic liquid by improving ionic mobility by decreasing the viscosity of the fluid, either as a solvent or as a plasticizer.

| Co-solvent | Molecular structure |
|---|---|
| FM2 | 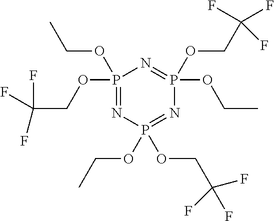 [SMILES: CCOP1(OCC(F)(F)F)=NP(OCC)(OCC(F)(F)F)=NP(OCC)(OCC(F)(F)F)=N1] |
| Monoglyme | 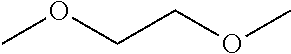 |
| Diglyme | 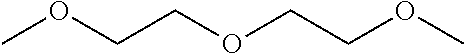 |
| FDEC | 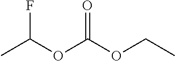 |
| FEMC | 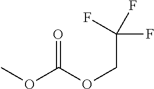 |

Overcharge of Li-ion batteries can lead to a series of gas evolution and thermal runaway reactions, which may result in disastrous cell failure. Exothermic parasitic reactions have been reported to occur at high voltages for the NMC-type electrodes. The thermal release during the high-voltage cycling, i.e., overcharging, may be used as a proxy for the safety evaluation of the electrolyte. The thermal release may be measured by the operando isotherm calorimetry, and the thermal release serves as an indirect and non-invasive probe of the reactions occurring inside the coin cell. Addition of inorganic liquid as a solvent or as a plasticizer for polymer and polymer composite electrolyte helps to diminish or extinguish this failure mode.

A phosphoranimine (PA) compound may be employed as a plasticizer, in addition to, or as an alternative to a phosphazene (PZ) plasticizer.

The inorganic liquids can be used as plasticizers for both lithium and non-lithium battery chemistries, such as sodium, potassium, aluminum, magnesium, manganese, vanadium, and the like. In such cases, the supporting salt and appropriate electrodes will of course correspond to the battery chemistry. Likewise, the gel electrolyte may be used in other electrochemical devices.

As used herein, the term “energy storage device” means and includes a device configured and comprising materials formulated to convert stored chemical energy into electrical energy or electrical energy into chemical energy. The energy storage device may include, but is not limited to, a battery or a capacitor. By way of example only, the energy storage device may be a metal-ion battery, a metal battery (e.g., Li, Na, K, Mg, Mn, V, etc.), an ultracapacitor, or a supercapacitor. In the case of capacitive energy storage systems, the formation of an SEI is not critical.

The pendant groups on the PA and/or PZ compound may be selected based on desired properties of the PA compound, such as to achieve sufficient stability, ion solvation and transport, polymer and polymer composite electrolyte plasticizing properties, and cell cyclability properties of the PA and/or PZ compound to be used as a component of the solid electrolyte. A desired balance of these properties may be achieved by appropriately selecting the pendant groups. The PA and/or PZ compound may be tailored to exhibit stability with respect to the electrochemical system chemistry (e.g., toward lithium or other metal, e.g., a high lithium or sodium salt, or other alkali metal, alkaline earth metal, transitional metal, or post transition metal salt), ion transport, solubility, stability at high voltage, low flammability, and low volatility by appropriately selecting the pendant groups. The viscosity of the PA and/or PZ compound may be directly proportional to the molecular weight of the PA and/or PZ compound, which is, in turn, affected by the molecular weight of the pendant groups. The viscosity of the entire formulation may, in turn, be related to the viscosity of the PA and/or PZ compound. To achieve the desired properties, the pendant groups may be selected to produce an asymmetric PA compound, i.e., a PA compound having different substituents on the phosphorus atom, which is believed to minimize molecular scale ordering and discourage a high extent of solvent self-association, aggressive multi-dentate bridging with an ionic species, and the generation of ordered or crystalline structures.

The phosphorus substituents may also be selected such that the PA and/or PZ compound does not easily conform to solvate cations past mono-dentate coordination, including electron withdrawing moieties, such as fluorine. The PA and/or PZ compound may also be formulated in the electrolyte solution with dissimilar compounds to avoid molecular association. These properties may directly impact the charge transfer process in the energy storage device where ions need to be able to readily associate and de-associate with solvent members through ion solvation, which has thermodynamic and kinetic costs in terms of energy and time requirements.

The pendant groups on the PA and/or PZ compound may be selected such that the PA and/or PZ compound is a liquid at room temperature (from about 20° C. to about 25° C.) and at the temperature of use, e.g., 0° C. or below to 60° C. or above, is stable at a temperature greater than about 150° C., and is substantially non-flammable at operating temperatures to which the electrolyte solution is exposed, e.g., ≤65° C., and more preferably has a flash point of at least 100° C. The PA and/or PZ compound of the electrolyte solution may also be stable at high voltages, such as greater than about 4.5 V (vs. Li/Li⁺), during cycling of the energy storage device including the electrolyte solution. The pendant groups on the PA and/or PZ compound may be selected such that the PA and/or PZ compound has an increased flash point and a decreased flame duration as compared to organic electrolytes, resulting in reduced flammability of the electrolyte.

The melting point of the PA and/or PZ compound may be in a range of from about −30° C. to about 25° C. so that the PA and/or PZ compound is a liquid at operating temperature. Note that the PA and/or PZ compound is a component of the solid electrolyte, and therefore the melting point of the PA and/or PZ compound alone is not dispositive. Since the PA and/or PZ compound is to be used in the energy storage device, such as a battery, the temperature of use may be within a range of from about −25° C. to about 250° C. To maintain the PA and/or PZ compound as a liquid, the pendant groups may include at least one of a fluorinated alkyl group, an aryl group, the organosilyl group, an oxygen-containing organic group, and a branched organic group on the nitrogen atom, and different R groups (R1, R2, R3) may be used on the phosphorus atom. By selecting the X group of a PA compound, as discussed below, from these functional groups, crystal packing may be disrupted so that the PA compound may remain a liquid at room temperature.

The PA and PZ compounds are considered inorganic compounds due to their phosphorus-nitrogen (P═N) parent structure.

A phosphine oxide functional group bonded to the nitrogen atom of the PA compound, i.e., X is [—P(═O)R2], may be avoided because the P═O bond is strongly attracted to lithium ions.

The phosphoranimine typically has the structure: X—N═P(R1, R2, R3), wherein X, R1, R2, and R3 are independently selected from the group consisting of inorganic and organic functional groups, wherein R1, R2, and R3 are represented by at least two different substituents. X may be selected from the group consisting of an organosilyl group and a tert-butyl group. R1. R2, and R3 may be independently selected from the group consisting of an alkoxy group, and an aryloxy group.

The phosphazene (PZ) may comprise a plurality of phosphazenes having respectively different pendent group substitution. The PZ may comprise a substituted PZ having substituents selected from the group consisting of alkoxy and fluorinated alkoxy groups. The substituted PZ may comprise at least one of an ethoxy substituent and a 2,2,2-trifluoroethoxy substituent.

The metal salt (supporting ion) may be a salt of lithium, sodium, potassium, magnesium, manganese, or other alkali metal or alkaline earth metal, or vanadium, or other metals. The solvent solution as a whole, may have a high salt solubility, such as from about 0.1 to 5 M, and for example, may be 0.5 M to about 1.2 M, or 0.8 to 1.1 M, in a solution of a metal salt, such as in a lithium salt solution, a sodium salt solution, other alkali metal solution, alkaline earth metal solution, transitional metal solution, or post transition metal solution. By way of example only, the lithium salt may be lithium hexafluorophosphate (LiPF₆), lithium tetrafluoroborate (LiBF₄), lithium perchlorate (LiClO₄), or combinations thereof.

The solvent system may provide a good ion cyclability in the energy storage device, such as at least a C/1 equivalent cycling rate. However, when used in consumer electronics, the battery including the solvent may exhibit a lower cycling rate.

The solid electrolyte may be used in an energy storage device (e.g., a battery or capacitor) that includes a positive electrode (e.g., a cathode), a negative electrode (e.g., an anode) separated from the positive electrode by a solid electrolyte having a plasticizer according to the present technology, with an SEI layer forming at electrode surfaces.

As described in Rollins, H. W., Harrup, M. K., Dufek, E. J., Jamison, D. K., Sazhin, S. V., Gering, K. L., & Daubaras, D. L., “Fluorinated Phosphazene Co-solvents for Improved Thermal and Safety Performance in Lithium-ion Battery Electrolytes”, Journal of Power Sources, 263, 66-74 (2014), electrolyte solutions of 20% PZ with carbonates extend the electrochemical window up to 1.85V over the baseline 0.85 V window exhibited by carbonate solutions alone. This beneficial trend should continue for PA/PZ mixtures. See also E. J. Dufek, M. L. Stone, D. K. Jamison, F. F. Stewart, K. L. Gering, L. M. Petkovic, A. D. Wilson, M. K. Harrup, H. W. Rollins, “Hybrid Phosphazene Anodes for Energy Storage Applications”, J. of Power Sources, 267 (2014) 347-355; and E. J. Dufek, J. R. Klachn, H. W. Rollins, M. K. Harrup, D. Jamison, “Phosphoranimine-based Battery Electrolytes”. J. of Power Sources, pending (2014).

Both PA and PZ have very low thermal degradation rates compared to pure carbonate electrolytes. PZ alone can act as a “free-radical sponge” when used in carbonate electrolytes to slow their thermal degradation. In Rollins et al (2015) vide supra, solutions containing only organic carbonate electrolytes completely degrade after about 55 days of being held at 60° C., leaving a black solid residue. Solutions containing both organic carbonate and quantities of PZ retained much of the carbonate through 245 days held at the same temperature, and only showed slight discoloration.

It is therefore an object to provide a solid electrolyte, comprising a solid material selected from the group consisting of at least one of a polymer, a ceramic material, and a polymer-ceramic composite material; and a phosphorus-containing plasticizer selected from the group consisting of a phosphazene and a phosphoranimine compound, which lacks hydroxyl and unstable phosphorus-halogen bonds, is electrochemically stable at a voltage of at least 3.5 V, and has a flash point of at least 65° C., more preferably at least 100° C., wherein the solid electrolyte has a lithium ion conductivity of at least 1×10⁻⁶ S/cm. It is also an object to provide a battery, comprising the solid electrolyte disposed between an anode and a cathode, further comprising a supporting salt.

The solid material comprises a polymer material, a ceramic material, or a polymer-ceramic composite material.

It is a further object to provide a battery, comprising: an anode configured to provide a source of metal ions; a cathode configured to complex with metal ions resulting in a change in oxidation state; a salt comprising metal ions, and a solid material with a phosphorus compound distributed therein. The phosphorus compound may be a phosphazene and/or a phosphoranimine compound, or combination thereof. The solid material may comprises a ceramic, a polymer-ceramic composite material, an ion conducting polymer material, poly(ethylene oxide), poly(ethylene glycol), a polyimide, a polymer composite material, an ionic polymer, and/or crystalline domains and amorphous domains.

The salt may be selected from the group consisting of lithium triflate (LiCF₃SO₃), lithium tetrafluoroborate (LiBF₄), lithium hexafluorophosphate (LiPF₆), lithium hexafluoroarsenate (LiAsF₆), lithium bromide (LiBr), lithium chlorate (LiClO₃), lithium nitrate (LiNO₃), lithium bis(oxalato)borate (LiB(C₂O₄)₂), lithium difluoro(oxalato)borate (LiC₂O₄BF₂), lithium metaborate (Li₂B₄O₇), lithium bis(trifluoromethanesulfonyl)imide (CF₃SO₂NLiSO₂CF₃), lithium bis(fluorosulfonyl)imide and combinations thereof. The salt may migrate into the solid electrolyte.

The phosphorus compound may comprise triethoxy tri-trifluoroethoxy phosphazene.

It is also an object to provide a lithium ion battery, comprising: an anode; a cathode, and a solid electrolyte plasticized with at least one of a phosphazene and phosphoranimine between the anode and cathode. The solid electrolyte may comprise an ion conducting polymer material, a ceramic material, or a composite of ceramic and polymer. The ceramic material comprises a garnet material.

The solid electrolyte may comprise garnet, a cubic garnet phase ceramic, a sulfide glass ceramic, a lithium ion conducting glass ceramic, a phosphate ceramic, an ion conducting polymer material, poly(ethylene oxide), poly(ethylene glycol), a polyimide, a polymer composite material, an ionic polymer, and/or crystalline domains and amorphous domains. It is a further object to provide use of a phosphazene and/or a phosphoranimine as a plasticizer in a solid electrolyte of a lithium-ion battery.

It is also an object to provide a solid electrolyte, comprising: a solid material selected from the group consisting of at least one of a polymer, a ceramic material, and a polymer-ceramic composite material; and a phosphorus-containing plasticizer selected from the group consisting of a phosphazene and a phosphoranimine compound, which lacks hydroxyl and unstable phosphorus-halogen bonds, wherein the solid electrolyte has a lithium ion conductivity of at least 1×10⁻⁶ S/cm.

The phosphorus-containing plasticizer may comprises a phosphazene compound and/or a phosphoranimine compound.

The solid material may comprise a polymer material, a ceramic material, and/or a composite ceramic and polymer material.

The solid electrolyte may be provided separating or formed between an anode and a cathode.

The solid electrolyte may further comprise a supporting salt.

It is a further object to provide a battery, comprising: an anode configured to provide a source of metal ions; a cathode configured to complex with metal ions resulting in a change in oxidation state; a salt comprising metal ions, and a solid material with a phosphorus compound distributed therein, the phosphorus compound being selected from the group consisting of at least one of a phosphazene and a phosphoranimine compound.

The solid material may comprise a ceramic, a polymer, an ionic polymer, or a polymer-ceramic composite material. The polymer may be an ion conducting polymer material. The ion conducting polymer material may comprise at least one of poly(ethylene oxide), poly(ethylene glycol), and a polyimide. The solid polymer may comprise crystalline domains and amorphous domains.

The salt may be selected from the group consisting of lithium triflate (LiCF₃SO₃), lithium tetrafluoroborate (LiBF₄), lithium hexafluorophosphate (LiPF₆), lithium hexafluoroarsenate (LiAsF₆), lithium bromide (LiBr), lithium chlorate (LiClO3), lithium nitrate (LiNO₃), lithium bis(oxalato)borate (LiB(C₂O₄)₂), lithium difluoro(oxalato)borate (LiC₂O₄BF₂), lithium metaborate (Li₂B₄O₇), lithium bis(trifluoromethanesulfonyl)imide (CF₃SO₂NLiSO₂CF₃), lithium bis(fluorosulfonyl)imide and combinations thereof, wherein the salt migrates into the solid electrolyte.

The phosphorus compound may comprise a phosphazene and/or a phosphoranimine. The phosphorus compound may comprise triethoxy tri-trifluoroethoxy phosphazene.

It is another object to provide a lithium ion battery, comprising: a lithium metal anode; a solid electrolyte comprising a ceramic material and an ion conducting polymer material, plasticized with at least one of a phosphazene and phosphoranimine, having lithium ions with a conductivity of at least 1×10⁻⁶ S/cm; and a lithium intercalation cathode.

### BRIEF DESCRIPTION OF THE DRAWINGS

FIG. 1 is a schematic illustration of a cross-sectional view of an energy storage device including a phosphazene ionic compound.

### DETAILED DESCRIPTION OF THE PREFERRED EMBODIMENTS

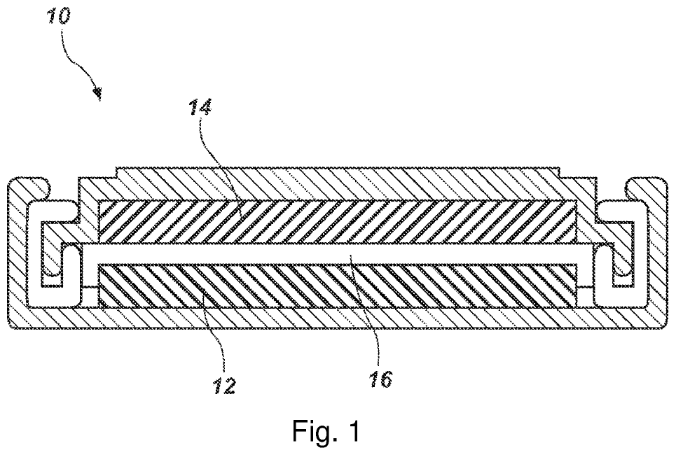

The electrolyte solution including the inorganic fluid compounds may be used in the energy storage device 10 (e.g., a battery) that includes a positive electrode 12 (e.g., a cathode), a negative electrode 14 (e.g., an anode), and a separator 16 between the electrodes 12, 14, as shown in FIG. 1. The solid electrolyte, with a phosphazene plasticizer, may be positioned as the separator 16 in contact with the positive electrode 12 and the negative electrode 14. The solid electrolyte may be an organic polymer, a phosphazene polymer (e.g., polyphosphazene), or a copolymer, or polymer/ceramic composite for example.

By way of example, the energy storage device 10 may be a lithium battery containing the plasticized solid electrolyte.

### EXAMPLES

### Example 1

### PA Synthetic Pathway

The synthesis of PAs for this purpose was accomplished using the established Neilson and Wisian-Neilson methods. The synthetic route includes the preparation an initial aminophosphine which is then oxidized to the corresponding PA using elemental bromine. Maximization of LiPF₆ solubility was accomplished by substituting the subsequent bromine group(s) on the PV center with various alkyl and etheric oxygen-containing pendant groups.

### Example 2

### PZ Synthetic Pathway

In an oven dried 500 ml flask, 50 g (0.144 moles) of the hexachlorocyclotriphosphazene trimer was dissolved in ˜300 ml anhydrous dioxane which was then added to the solution of sodium ethoxide (under nitrogen at room temperature) and heated at sub-reflux for 5 hours and the reaction progress was monitored by 31P NMR. This solution was then cooled to room temperature and then added to a solution of sodium trifluoroethoxide (at RT under nitrogen). This solution was heated to sub reflux for ˜5 hours. This reaction was also followed by 31P NMR. When the reaction was complete, the solution was allowed to cool to room temperature and the excess ethoxides were quenched with water. The solution was neutralized with 2 M HCl. The solvent was removed by rotary evaporation leaving the PZ product (a liquid) and undissolved solid sodium chloride. The product separated from the salt by decantation and taken up in dichloromethane and washed with nanopure (18 MΩ cm) water in a separatory funnel six times to remove trace impurities. The dichloromethane was removed from the product on a rotary evaporator and the product was then dried in an argon purged vacuum oven for several days, refreshing the atmosphere with fresh UHP argon daily.

Although both classes of phosphorus compounds have been previously investigated individually, this work has been founded on the use of these compounds individually in combination with traditional organic carbonate-based solvents in an attempt to reduce the shortcomings of use of these solvents. According to the present technology, organic carbonates are generally excluded as a substantial component of the formulation altogether, to form a new all-inorganic electrolyte. For example, <2% of the solvent is organic carbonates. This electrolyte is compatible with most known lithium ion battery components in widespread use today. These include the anode, the cathode, electrode binders, and the mechanical separator, as well as common casing components. As such, the overall processes and key materials for the commercial manufacture of lithium ion batteries are altered little if even at all from current methodologies. The embodiment of this invention is a lithium-ion based battery system that uses an electrolyte mixture of one or more PA components as the primary solvent, and one or more PZ components as the co-solvent. In the preferred embodiment, the mixture is composed primarily of one or more PA components (that is, PZ components comprising less than 50% of the solvent by volume). In a more preferred embodiment, the PZ components are present in the range of 10 to 20% by volume.

US Patent Application No. 20150340739 describes an embodiment of the PA. In the preferred embodiment, the PA includes an organosilyl group or a tert-butyl group with substituents R1, R2, and R3 is independently selected from the group consisting of an alkyl group, an aryl group, an alkoxy group, or an aryloxy group. In another embodiment, each of R1, R2, and R3 is independently selected from a cationic pendant group, which includes but is not limited to an ionic form of an aromatic amine, an aryl amine, or an aliphatic amine, such as a nitrogen containing aryl group, a primary amine, a secondary amine, or a tertiary amine. The aromatic amine may be an aniline group. The nitrogen containing aryl group may include, but is not limited to, a pyrrole group, an imidazole, a pyrazole, a pyridine group, a pyrazine group, a pyrimidine group, or a pyridazine group.

In the embodiment, the PZ mixture includes at least one cyclic PZ compound, having a 6-membered alternating P—N ring structure, and with each phosphorus atom having 2 constituent functional groups attached to it. These functional groups may include a combination of alkoxy and fluorinated alkoxy groups, as described in Rollins, Harry W., Mason K. Harrup, Eric J. Dufek, David K. Jamison, Sergiy V. Sazhin, Kevin L. Gering, and Dayna L. Daubaras. “Fluorinated phosphazene co-solvents for improved thermal and safety performance in lithium-ion battery electrolytes.” Journal of Power Sources 263 (2014): 66-74. One example of this preferred embodiment, is where these groups are, respectively, ethoxy (CH3—CH2—O—) and 2,2,2-trifluoroethoxy (CF3—CH2—O—).

PA and PZ compounds may decompose into MP species is during the formation of the SEI layer during battery operation.

### Example 3

### Polymeric Solid Electrolytes

Embodiments of the present invention provide cathode materials and composites formed from certain lithium salts, for example lithium bis(oxalato)borate or lithium bis(trifluoromethanesulfonyl)imide, used in combination with a polymer such as poly(ethylene oxide) or other ceramic materials or polymer/ceramic composite materials.

Embodiments of the present invention provide electrolyte materials formed from certain lithium salts, for example lithium bis(oxalato)borate or lithium bis(trifluoromethanesulfonyl)imide, used in combination with a polymer e.g., PEO as well as other ceramic materials or polymer/ceramic composite materials.

Embodiments of the present invention include a lithium-ion battery having an anode, a solid electrolyte, and a cathode. The cathode comprises an electrode active material, a first lithium salt, and a polymer material. The solid electrolyte can include a second lithium salt. The polymer material is plasticized with a phosphorus compound, e.g., a phosphazene or a phosphoranimine. In the case of a borate lithium salt, the PA and/or PZ may also have a boron-containing substituent.

Embodiments of the present invention include a lithium-ion battery having an anode, a solid electrolyte, and a cathode. The solid electrolyte may comprise a polymer, a ceramic material and/or a polymer/ceramic composite material, a first lithium salt, and a polymer material. The solid electrolyte can include a second lithium salt. The polymer material is plasticized with a phosphorus compound, e.g., a phosphazene, phosphoranimine, or a combination therein.

Solid-state batteries can be formed using polymeric materials with ion conducting properties. The polymeric materials can be used in the solid electrolyte. The polymer should have suitable mechanical properties and thermal stability, in addition to the desired level of ionic conductivity, and specifically lithium-ion conductivity. As with other applications using polymeric materials, the properties of the solid structure can be influenced by (i) the choice of polymer, (ii) the molecular weight of the polymer, (iii) the polydispersity of the polymer, (iv) the processing conditions, and (v) the presence of additives.

Poly(ethylene oxide) (“PEO”) is a suitable polymer for use in lithium ion solid-state batteries. PEO is a commodity polymer available in a variety of molecular weights. PEO can range from very short oligomers of about 300 g/mol (or 300 Da) to very high molecular weights of 10,000,000 g/mol (or 10,000 kDa). At molecular weights of 20 kDa and below, PEO is typically referred to as poly(ethylene glycol) or PEG. PEO has been used as a separator in conventional liquid electrolyte systems and, as described above, as a component in a thin film solid electrolyte.

PEO processed into a structure can have both crystalline and amorphous domains. Ionic conductivity happens more readily in the amorphous domains and, therefore, processing conditions that decrease crystalline domain size and/or the overall amount of crystallinity are preferred. Some research has used carbonate solvents, such as ethylene carbonate, dimethyl carbonate, or diethyl carbonate, as plasticizers to improve ionic transport and reduce interfacial impedance. However, this involves the addition of a volatile, flammable liquid to the battery and negates much of the safety benefits brought by a solid-state electrolyte. In PEO systems, PEG can be added to achieve the desired processing properties, such as a preferred solution viscosity, film modulus, or film glass transition temperature.

While PEO is discussed herein as a preferred polymeric material, it is understood that other polymers with equivalent chemical, electrochemical, mechanical, and/or thermal properties can be used in place of or in addition to PEO and/or PEO/PEG mixtures. Further, copolymers that include PEO, PEG, or PEO-like polymers in at least one segment of the copolymer can be suitable for certain embodiments described herein. Thus, the embodiments described herein that refer to PEO or PEO/PEG are understood to encompass other such polymeric and co-polymeric materials.

According to some aspects discussed herein, certain lithium salts added to polymeric materials improve the performance of solid-state batteries. Specifically, a lithium salt concentration in a PEO such that the ether oxygen (EO) to lithium ion ratio is about 3:1 (that is, [EO]:[Li+]=3:1) results in maximum ionic conductivity in the PEO films, and may range, for example, from about 2:1 to about 4:1. Mechanical properties of the lithium salt/polymer composites are controlled by the molecular weight of the PEO, the ratio of PEO/PEG, and the process used to make the film (e.g., the type and nature of the solvent used for casting).

The PEO (or other polymer) is plasticized with a phosphorus compound selected from the group consisting of at least one of a phosphazene, phosphoranimine, and/or a combination therein, for example in an amount of 0.25% by weight to 25% by weight.

Plasticizers are commonly added to polymers such as plastics and rubber, either to facilitate the handling of the raw material during fabrication, or to meet the demands of the end product's application. For example, plasticizers are commonly added to polymers to make them soft and pliable. Plasticizers for polymers are either liquids with low volatility or solids.

It was commonly thought that plasticizers work by embedding themselves between the chains of polymers, spacing them apart (increasing the “free volume”), or swelling them and thus significantly lowering the glass transition temperature for the plastic and making it softer; however, it was later shown that the free volume explanation could not account for all of the effects of plasticization. The molecules of plasticizer take control over mobility of the chain, and the polymer chain does not show an increase of the free volume around polymer ends; in the case that the plasticizer/water creates hydrogen bonds with hydrophilic parts of polymer, the associated free volume can be decreased.

The effect of plasticizers on elastic modulus is dependent on both temperature and plasticizer concentration. Below a certain concentration, referred to as the crossover concentration, a plasticizer can increase the modulus of a material. The material's glass transition temperature can decrease at all concentrations. In addition to a crossover concentration a crossover temperature exists. Below the crossover temperature the plasticizer will also increase the modulus.

Suitable lithium salts include, but are not limited to, lithium triflate (LiCF₃SO₃), lithium tetrafluoroborate (LiBF₄), lithium hexafluorophosphate (LiPF₆), lithium hexafluoroarsenate (LiAsF₆), lithium bromide (LiBr), lithium chlorate (LiClO₃), lithium nitrate (LiNO₃), lithium bis(oxalato)borate (LiB(C₂O₄)₂) (also referred to herein as “LiBOB”), lithium difluoro(oxalato)borate (LiC₂O₄BF₂), lithium metaborate (Li₂B₄O₇), lithium bis(trifluoromethanesulfonyl)imide (CF₃SO₂NLiSO₂CF₃) (also referred to herein as “LiTFSI”), and combinations thereof.

According to the present invention, the phosphorus compound selected from the group consisting of at least one of a phosphazene, phosphoranimine, and/or a combination therein may be used in addition to, or instead of, LiBOB according to the prior technology. The phosphorus compound selected from the group consisting of at least one of a phosphazene and a phosphoranimine compound may be complexed with lithium ions, so that it acts as a lithium salt.

Using the formulations of polymer and salt generally described above, electrolyte structures and electrode structures can be formed for lithium-ion batteries. In certain aspects, solid electrolytes are formed from a polymer and a phosphorus compound selected from the group consisting of at least one of a phosphazene, phosphoranimine, and/or a combination therein which may optionally be provided with a lithium salt.

The cathode may include domains of active material and domains of conductive carbon. A binder may also be present. The active material can be any active material or materials useful in a lithium ion battery, including the active materials in lithium metal oxides or layered oxides (e.g., Li(NiMnCo)O₂), lithium rich layered oxide compounds, lithium metal oxide spinel materials (e.g., LiMn₂O₄, LiNi_{0.5}Mn1.5O₄), olivines (e.g., LiFePO₄, etc.). Active materials can also include compounds such as silver vanadium oxide (SVO), metal fluorides (e.g., CuF₂, FeF₃), and carbon fluoride (CFx). More generally, the active materials for cathodes can include phosphates, fluorophosphates, fluorosulphates, silicates, spinels, and composite layered oxides.

Polymer/lithium salt materials and composites may be used in the formation of anodes. Appropriate active materials for use in such anodes include, but are not limited to, graphitic and non-graphitic carbons, silicon and silicon alloys, lithium tin oxide, other metal alloys, and combinations thereof.

Cathodes and/or anodes for solid-state batteries may be formed from an active material, a polymer, and the current disclosed plasticizers.

The electrolyte may be formed from a composite of domains of a polymer/lithium ion formulation and domains of a lithium ion conducting ceramic, herein termed a polymer composite or polymer composite material. The lithium ion conducting material can be a garnet material such as a cubic garnet phase Li_{6.5}La₃Zr_{1.5}Ta_{0.5}O₁₂ (LLZTO), sulfides such as Li₁₀SnP₂S₁₂ (LSPS) and P₂S₅—Li₂S glass, lithium ion conducting glass ceramics (LIC-GC) such as Li_{1+x+y}AlₓTi₂₋ₓSi_{y}P_{3-y}O₁₂, phosphates such as Li_{1.3}Ti_{1.7}Al_{0.3}(PO₄)₃ (LTAP) or Li₂PO₂N (LiPON), or combinations thereof.

A general formula for garnet materials, which can be abbreviated as (LLMO), is

Li₃₊ₓLa_{3-y}A_{y}M₂O₁₂

where M can be a variety of different elements, including but not limited to, titanium (Ti), zirconium (Zr), niobium (Nb), tantalum (Ta), antimony (Sb), bismuth (Bi) and combinations thereof, and A can also be a variety of different elements, including but not limited to, barium (Ba). Generally, x<=4 and y<=1.

### Example 4

### Preparation of Solid Electrolyte Films

A solution of PEO, PEG, FM2 and the desired lithium salt or salts is prepared by weighing the desired ratios of solids, followed by addition of a solvent (such as acetonitrile). The solution is stirred aggressively overnight in an argon filled glove box (M-Braun, O₂ and humidity content<0.1 ppm). A film is cast from the slurry using a doctor blade onto a Teflon substrate, and is then air-dried. The film is annealed at 100 degrees C. under vacuum for 12 hours, and then cooled. A freestanding film can then be peeled from the substrate, and cut or punched to the appropriate size and shape. The punched films are dried at 60 degrees C. under vacuum for about an hour.

The FM2 concentration is, for example, 1-5%, 5-10%, 5-25%, and 10-50% by weight.

In some cases, the solid electrolyte is a polyphosphazene, plasticized with cyclic phosphazene(s) and/or phosphoranimine(s).

### Example 5

### Battery Cell Assembly

Battery cells may be formed in a high purity argon filled glove box (M-Braun, O₂ and humidity content<0.1 ppm). A silver-vanadium oxide (“SVO”) cathode film and a lithium metal anode electrode may be used. Each battery cell includes the composite cathode film prepared as described above, a solid polymer electrolyte prepared as described above, and a lithium metal anode film. Annealing of the stack of cathode/electrolyte films may be performed at 110° C. on a hot plate for 1 hour prior to putting in the cell with lithium and crimping the cell together. Assembly may be performed under argon.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to the range of values approximately near the given value in order to account for typical tolerance levels, measurement precision, or other variability of the embodiments described herein. Absent another suitable metric disclosed herein, the term “about” shall mean a range of −20%/+25% of the nominal value.

A “C-rate” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

Ranges presented herein are inclusive of their endpoints. Thus, for example, the range 1 to 3 includes the values 1 and 3 as well as the intermediate values.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. The scope of the disclosure is intended to encompass all combinations, subcombinations, and permutations of the various disclosures herein (regardless of whether in multiple-dependent format), and unless specifically limited by the claims, no particular aspect is considered essential. Likewise, the invention comprises materials and methods that facilitate production of an end product and portions of the end product. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

While the disclosure is susceptible to various modifications and alternative forms, specific embodiments have been shown by way of example in the drawings and have been described in detail herein. However, the disclosure is not intended to be limited to the particular forms disclosed. Rather, the disclosure encompasses all modifications, combinations, equivalents, and alternatives falling within the scope of the disclosure as defined by the following appended claims and their legal equivalents.

We claim:

1. A solid electrolyte, comprising:
a solid material selected from the group consisting of at least one of a polymer, a ceramic material, and a polymer-ceramic composite material; and
at least one phosphorus-containing plasticizer selected from the group consisting of a phosphazene and a phosphoranimine compound, which lacks hydroxyl and unstable phosphorus-halogen bonds,
wherein the solid electrolyte has a lithium ion conductivity of at least 1×10⁻⁶ S/cm.

2. The solid electrolyte according to claim 1, wherein the at least one phosphorus-containing plasticizer comprises a phosphazene compound.

3. The solid electrolyte according to claim 1, wherein the at least one phosphorus-containing plasticizer comprises a phosphoranimine compound.

4. The solid electrolyte according to claim 1, wherein the solid material comprises a polymer material.

5. The solid electrolyte according to claim 1, wherein the solid material comprises a ceramic material.

6. The solid electrolyte according to claim 1, further comprising an anode and a cathode separated by the solid electrolyte.

7. The solid electrolyte according to claim 1, further comprising a supporting salt.

8. A battery, comprising:
an anode configured to provide a source of metal ions;
a cathode configured to complex with metal ions resulting in a change in oxidation state;
a salt comprising metal ions, and
a solid material with at least one phosphorus compound distributed therein, the at least one phosphorus compound being selected from the group consisting of at least one of a phosphazene and a phosphoranimine compound.

9. The battery according to claim 8, wherein the solid material comprises a ceramic.

10. The battery according to claim 8, wherein the solid material comprises a polymer-ceramic composite material.

11. The battery according to claim 8, wherein the solid material comprises an ion conducting polymer material.

12. The battery of claim 11, wherein the ion conducting polymer material comprises at least one of poly(ethylene oxide) and poly(ethylene glycol).

13. The battery of claim 11, wherein the ion conducting polymer material further comprises a polyimide.

14. The battery of claim 8, wherein the solid polymer comprises an ionic polymer.

15. The battery of claim 8, wherein the solid polymer comprises crystalline domains and amorphous domains.

16. The battery of claim 8, wherein the salt is selected from the group consisting of lithium triflate (LiCF₃SO₃), lithium tetrafluoroborate (LiBF₄), lithium hexafluorophosphate (LiPF₆), lithium hexafluoroarsenate (LiAsF₆), lithium bromide (LiBr), lithium chlorate (LiClO3), lithium nitrate (LiNO₃), lithium bis(oxalato)borate (LiB(C₂O₄)₂), lithium difluoro(oxalato)borate (LiC₂O₄BF₂), lithium metaborate (Li₂B₄O₇), lithium bis(trifluoromethanesulfonyl)imide (CF₃SO₂NLiSO₂CF₃), lithium bis(fluorosulfonyl)imide and combinations thereof, wherein the salt migrates into the solid electrolyte.

17. The battery of claim 8, wherein the at least one phosphorus compound comprises a phosphazene.

18. The battery of claim 8, wherein the at least one phosphorus compound comprises a phosphoranimine.

19. The battery of claim 8, wherein the at least one phosphorus compound comprises triethoxy tri-trifluoroethoxy phosphazene. 20 A lithium ion battery, comprising:
a lithium metal anode;
a solid electrolyte comprising solid material selected from the group consisting of at least one of a polymer, a ceramic material, and a polymer-ceramic composite material, plasticized with at least one of a phosphazene and phosphoranimine, having lithium ions with a conductivity of at least 1×10⁻⁶ S/cm; and
a lithium intercalation cathode.
